(19) United States
(12) Patent Application Publication
(10) Pub. No.: US 2026/0192779 A1
(43) Pub. Date: Jul. 9, 2026

(54) INFORMATION PROJECTION METHOD AND INFORMATION PROJECTION APPARATUS

(71) Applicant: MAXELL, LTD., Kyoto (JP)

(72) Inventors: Naoyuki SUZUKI, Otokuni-gun (JP); Yasuhiko KUNII, Otokuni-gun (JP)

(21) Appl. No.: 19/438,766

(22) Filed: Jan. 2, 2026

(30) Foreign Application Priority Data
Jan. 7, 2025 (JP) 2025-002492

(51) Int. Cl. B60S 1/08; B60Q 1/50; G06V 10/60; G06V 20/56; G07C 5/08

(52) U.S. Cl. CPC B60S 1/0896; B60Q 1/543; G06V 10/60; G06V 20/588; G07C 5/0825; B60Q 2400/50; B60S 1/0818

(57) ABSTRACT

To provide technology that enables more appropriate display of images for the driver and images for people around the vehicle. This invention contributes to Sustainable Development Goal 3: Good Health and Well-Being. An information projection apparatus is mounted on a vehicle and is apparatus projects image onto a road surface. The information projection apparatus includes a receiver for acquiring information related to the vehicle and a projection or image projector for projecting images. The information projection apparatus determines whether to project an image onto the road surface based on information about the wiper acquired by the receiver.

### BACKGROUND OF THE INVENTION

### Field of the Invention

The present invention relates to an information projection method and an information projection apparatus.

### Description of the Related Art

As shown in Patent Document 1 and Patent Document 2, techniques for projecting information onto road surfaces are known.

JP-A-2012-247369 discloses a vehicle projection device that projects route guidance images onto the road surface ahead of the vehicle. This vehicle projection device includes route search means for searching the current position of the vehicle and a route from said current position to a set destination, and projection means for projecting a route guidance image onto the road surface in front of the vehicle, based on the route information searched by said route search means, to guide the vehicle toward a branch direction, when the vehicle approaches a branch point on said route to a degree visible to occupants.

JP-A-2008-7079 discloses a technology capable of clearly alerting moving objects such as pedestrians, disclosing a road surface projection method as one example. This road surface projection method includes a step of storing image data of an image to be projected onto the road surface in advance, a step of monitoring the area surrounding the vehicle, a step of identifying a moving object based on the monitoring result, and a step of setting an identification area within the monitored surrounding area, and reading out the stored image data in advance when the identified moving object is present within the identification area, and projecting the image onto the road surface position near the moving object.

There is a need to provide technology that enables more appropriate display of images for the driver and images for vehicles around the vehicle and people.

### SUMMARY OF THE INVENTION

According to an embodiment of the present invention, an following information projection apparatus is provided. This information projection apparatus is mounted on a vehicle and projects images onto the road surface. The information projection apparatus includes a receiver that acquires information related to the vehicle and a projection or image projector that projects images. The information projection apparatus determines whether to project images onto the road surface based on information related to the wiper acquired by the receiver.

Furthermore, according to an embodiment of the present invention, the following information projection method is provided. This information projection method is an information projection method for an information projection apparatus mounted on a vehicle and projecting images onto the road surface. In this information projection method, the processor acquires information regarding the wiper's operating mode and, based on the wiper's operating mode, determines whether to project an image onto the road surface using at least one piece of information from the wiper's continuous wiping time and the rain sensor's output value. The processor then controls the projection of the image by the Information projection apparatus based on the result of the determination.

### Advantageous Effect

According to the present invention, a technology is provided that enables more appropriate display of images for the driver and images for vehicles around the vehicle and people. Note that, other issues, configurations, and effects not mentioned above will become apparent from the description of embodiments for implementing the invention.

### BRIEF DESCRIPTION OF THE DRAWINGS

FIG. 1 is a diagram showing an example of an overview of a vehicle implementing an information projection apparatus.

FIG. 2 is a diagram showing an example of configuration provided in the vehicle.

FIG. 3A is a diagram showing an example of an image display when projecting information onto the road surface in front of the vehicle.

FIG. 3B is a diagram showing an example of an image display when projecting information onto the road surface behind the vehicle.

FIG. 4A is a diagram showing an example of a configuration of the projection apparatus.

FIG. 4B is a diagram showing an example of a configuration of the projection apparatus.

FIG. 4C is a diagram showing an example of a configuration of the projection apparatus.

FIG. 5A is a diagram illustrating an example of the arrangement of optical components and the like.

FIG. 5B is a diagram illustrating an example of the arrangement of optical components and the like.

FIG. 5C is a diagram illustrating an example of the arrangement of optical components and the like.

FIG. 6 is a diagram showing an example of a display area for images as seen by the driver.

FIG. 7 is a diagram illustrating an example of a display area where an image light is projected.

FIG. 8 is a flowchart showing an example of control.

FIG. 9 is a flowchart showing a more specific example of the control in S4.

FIG. 10 is a diagram illustrating an example of a determination that is a projection start determination (S2).

FIG. 11 is a diagram illustrating an example of the lighting mode of the projection apparatus.

FIG. 12 is a diagram illustrating an example of acquired information in S3.

FIG. 13 is a diagram illustrating an example of a determination in S4.

FIG. 14 is a diagram illustrating an example of control in S4 using road surface information.

FIG. 15 is a diagram illustrating an example of a determination that is a projection end determination (S6).

### MODE FOR CARRYING OUT THE INVENTION

Hereinafter, the embodiments of the present invention will be described with reference to the drawings. The embodiments are examples for illustrating the present invention, and omissions and simplifications have been made as appropriate for clarity of explanation. The present invention may be implemented in various other forms. Unless specifically limited, each element may be singular or plural.

The positions, such as positions, sizes, shapes, and ranges of the components shown in the drawings may not represent their actual positions, such as sizes, shapes, or ranges, intended to facilitate understanding of the invention. Therefore, the invention is not necessarily limited to the positions, sizes, shapes, or ranges disclosed in the drawings.

Various types of information may be described using expressions such as "table," "list," or "queue," but such information may also be represented using other data structures. For example, information such as "XX table," "XX list," or "XX queue" may also be referred to as "XX information." When describing identification information, terms like "identification information," "identifier," "name," "ID," or "number" are used, and these terms are replaceable.

When multiple components have identical or similar functions, they may be described using the same symbol with different subscripts. Conversely, when no distinction between these multiple components is necessary, the subscript may be omitted in the description.

In the embodiments, processing performed by executing a program may be described. Here, a computer executes the program using a processor (e.g., CPU, GPU), utilizing storage resources (e.g., memory) and interface devices (e.g., communication ports), to perform the processing defined by the program. Therefore, the processor may be considered the processing subject performing executed by the program. Similarly, the processing subject performing executed by the program, may be a controller, device, system, computer, or node that includes a processor. The processing subject performing executed by the program, may be an arithmetic unit and may include dedicated circuits for performing specific processing. Here, dedicated circuits is, for example, FPGA (Field Programmable Gate Arrays) or ASIC (Application Specific Integrated Circuit), CPLD (Complex Programmable Logic Device), etc.

The program may be installed on a computer from a program source. The program source may be, for example, a program distribution server or a computer-readable storage medium. When the program source is a program distribution server, the program distribution server includes a processor and storage resources for storing the program to be distributed, and the processor of the program distribution server may distribute the program to other computers. Furthermore, in embodiments, two or more programs may be implemented as a single program, or a single program may be implemented as two or more programs.

The embodiment describes an example of a technique for displaying information on the road surface using a projection apparatus mounted on a vehicle. Note that, in the embodiment, for the vehicle and driver, the horizontal direction refers to the left-right direction, the vehicle's lateral direction, or the vehicle's width direction, the vertical direction refers to the vehicle's up-down direction or longitudinal direction, and the vertical direction perpendicular to the vehicle's lateral direction refers to the vehicle's front- rear direction or the vehicle's direction of travel.

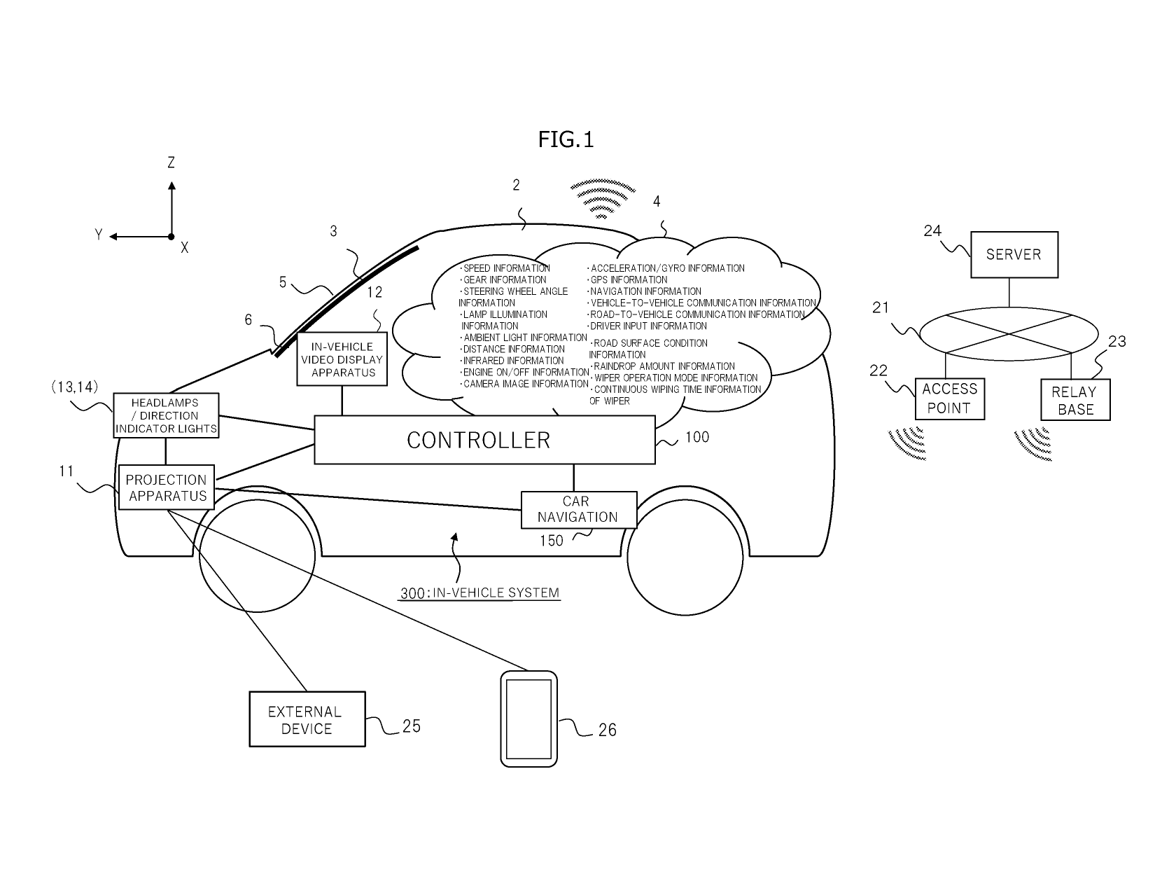

FIG. 1 is a schematic diagram showing the vehicle. As shown in FIG. 1, the vehicle 2 includes, for example, a projection apparatus 11 (information projection apparatus), an in-vehicle video display apparatus 12, a car navigation 150, headlamps 13 (i.e., headlights 13), tail lights (not shown), direction indicator lights 14, and a controller 100. Furthermore, the vehicle 2 incorporates an in-vehicle system 300 comprising these components. This in-vehicle system 300 implements an in-vehicle network, and the controller 100 be able to transmit and receive data or information with such as these components, other components described later. The in-vehicle system 300 implements, for example, CAN (Controller Area Network), in-vehicle Ethernet, LIN (Local Interconnect Network), etc.

Furthermore, the in-vehicle system 300 can communicate with the vehicle's external environment via a communication device. Examples of communication with the vehicle's external environment, it is used to direct communication methods and indirect communication methods. The direct communication method uses such as the 760 MHz band, the 5.9 GHz band, internationally as ITS (Intelligent Transport System) communication bands, for direct communication between vehicles and vehicles, roads and vehicles, and pedestrians and vehicles, in contrast, the indirect communication method uses mobile phone bands other than 5.9 GHz to communicate indirectly via mobile carrier networks. The in-vehicle system 300 can, for example, send and receive data or information with a server 24 connected to network 21 via an access point 22 or relay base 23 on network 21. It may also communicate with other vehicles, external devices 25, information terminals 26 held by pedestrians, or infrastructure such as terminals installed on the road the vehicle is traveling on. Examples of road-to-vehicle communication, it is performed receiving traffic congestion information and weather information using radio beacons or optical beacons.

Vehicle information 4, an example of data or information acquired by the in-vehicle system 300, includes in-vehicle sensor information, for example, such as speed information, gear information, steering wheel angle information, lamp illumination information, ambient light information, distance information, infrared information, engine ON/OFF information, camera image information, acceleration/gyro information, GPS information, navigation information, vehicle-to-vehicle communication information, road-to-vehicle communication information, pedestrian-to- vehicle communication information, Lidar (Light Detection and Ranging), road surface condition information, raindrop-related information, wiper-related information. Camera image information includes both in-vehicle and outside-vehicle camera image information. GPS information includes current time information and latitude and longitude information. This vehicle information can be obtained, for example, from the sensors described later.

Also, vehicle information 4 includes information input by the driver. The driver can input information using an appropriate device for information input. This device may be one pre-installed in the vehicle. This device may also be an external device connectable to the In-vehicle system 300 via wired or wireless means, as an input device, tablet, smartphone, AR (Augmented Reality) glasses, HMD (Head Mounted Display), other wearable devices, or a personal computer.

The in-vehicle system 300 can execute various controls, such as driving control and display control, using the acquired data or information.

The projection apparatus 11 projects an image light for displaying information. Note that, a specific configuration example of the projection apparatus 11 will be described later. The driver, persons around the vehicle 2 that is pedestrians walking near the vehicle, drivers and passengers of other vehicles traveling near the vehicle, etc., can see the images projected by the projection apparatus 11.

The in-vehicle video display apparatus 12 generates an image light for displaying information and projects the image light toward a predetermined display area 5 on the windshield 3. This enables the in-vehicle video display apparatus 12 to superimpose a virtual image corresponding to the displayed image onto the scenery, allowing the vehicle driver (driver's viewpoint) to see it. Note that, in this example, the image light is projected onto the display area 5 of the windshield 3, but the projection or image projector projecting the image light may also be a projection component such as a combiner. The in-vehicle video display apparatus 12 may be a known HUD (Head-Up Display) comprising, for example, a light source, a display panel forming the display image, and a control unit.

Car navigation 150 is an electronic device called a car navigation system. Car navigation 150 is a device that, for example, utilizes map information, indicate the current location by position information by GPS and the route to the destination. Car navigation 150 can utilize traffic information, such as VICS (Vehicle Information and Communication System, registered trademark), to present an efficient route to the destination.

In this example, headlights 13 are provided in a pair, left and right, at the front of the vehicle. Lamps, which are light-emitting elements, are incorporated inside the headlights 13. Direction indicator lights 14 are devices for indicating the direction to the surrounding area, when turn right or left, lane changes, etc., like the headlights 13, they are provided in a pair, left and right, at the front of the vehicle.

Controller 100 is an electronic control unit (ECU) installed within vehicle 2, as one example, includes a processing device (e.g., a central processing unit), a storage device, and an input/output device (I/O unit). The storage device can be configured using, for example, a main storage device and an auxiliary storage device. The main storage device is a work area of processing device, and the processing device stores data in the main storage device and executes data processing. Note that, the main storage device is, for example, RAM (Random Access Memory). The auxiliary storage device is a non-volatile storage device that stores data nonvolatile. The auxiliary storage device is, for example, ROM (Read-Only Memory).

Data or information is input to controller 100 via input/output devices and the in-vehicle network. Controller 100 can also control various devices connected to the in-vehicle network, via input/output devices and the in-vehicle network.

For example, vehicle information 4 and information acquired from server 24 are input to controller 100 via input/output devices. Controller 100 may then control, based on the acquired information, such as the operation of headlight 13, the operation of direction indicator lights 14, the operation of projection apparatus 11, the operation of in-vehicle video display apparatus 12, the operation of car navigation 150.

Projection apparatus 11 may be connected to various sensors mounted on vehicle 2, devices mounted on vehicle 2 (e.g., car navigation system 150), communication devices used for communication with the vehicle's exterior, and may acquire data or information. Projection apparatus 11 may then generate an image light for displaying information using the acquired data or information, and may project the image light.

Note that, the projection apparatus 11 may omit communication with the controller 100. Here, the projection apparatus 11 may acquire data or information from a configuration different from the controller 100, for example, via communication based on CAN, in-vehicle Ethernet, etc. Note that, the same can be applied to the in-vehicle video display apparatus 12.

Additionally, the controller 100 may generate video data using the acquired data or information, transmit the generated video data to the projection apparatus 11, and the projection apparatus 11 may generate an image light for displaying information based on the video data generated by the controller 100 and project the image light. Alternatively, the controller 100 may not generate video data, and instead, the image generation may generate video data and transmit the generated video data to the projection apparatus 11. Here, the controller 100 and the projection apparatus 11 may communicate based on, for example, FPD-Link III or GMSL (Gigabit Multimedia Serial Link), and the projection apparatus 11 may acquire the image data from the controller 100. Furthermore, the projection apparatus 11 performs processing on video that requires video processing, in video processing, it is performed processing relate to such as image distortion correction, color correction, brightness correction, contrast correction, and conversion (e.g., decoding). Regarding the video data, it may be stored in advance in the memory devices of the controller or projection apparatus, or it may be processed in real time without being stored in memory device. If stored in advance in the memory devices of the controller or projection apparatus, the stored video data may be sequentially changed by system updates or user operations, by wired or wireless methods. Note that, similar to the above description, this projection apparatus 11 may be connected to various sensors mounted on the vehicle, devices mounted on the vehicle 2 (e.g., car navigation 150), communication devices used for communication with the vehicle's exterior, etc., and may acquire data or information via communication based on CAN, in-vehicle Ethernet, etc. This projection apparatus 11 may generate an image light for displaying information based on the acquired information and project the image light. Note that, the same can be applied to the in-vehicle video display apparatus 12.

Additionally, controller 100 may control headlight 13 and projection apparatus 11 in coordination. For example, controller 100 may turn on headlight 13 and cause projection apparatus 11 to project image light forward of the vehicle. Furthermore, the controller 100 may, for example, turn off the headlight 13 and cause the projection apparatus 11 to generate an image of the information to be displayed and project the image light forward of the vehicle. That is, the headlight 13 and the projection apparatus 11 may perform coordinated operation via the controller 100.

On the other hand, the headlight 13 and the projection apparatus 11 may operate without going through the controller 100. For example, the headlight 13 and the projection apparatus 11 may be connected, and the operation of the headlight 13 may be controlled by the projection apparatus 11 (more specifically, the control unit of the projection apparatus 11). The projection apparatus 11 may, for example, turn on the headlight 13, generate an image of the information to be displayed, and project the image light forward of the vehicle. The projection apparatus 11 may also, for example, turn off the headlight 13, generate an image of the information to be displayed, and project the image light forward of the vehicle.

The projection apparatus 11 may be mounted, for example, at the front of the vehicle body, and the image light from projection apparatus 11 may be projected onto the road surface in front of the vehicle. The projection apparatus 11 may be mounted, for example, near the roof of vehicle body 2. The projection apparatus 11 may also be mounted, for example, on the side mirror portion, on the roof, on the side of vehicle body 2, on the bottom surface, etc. Note that, the present invention is not limited to these.

The projection apparatus 11 may be mounted in one or a plurality of units. For example, the projection apparatus 11 may be mounted in a pair at the front end of the vehicle 2. Furthermore, the projection apparatus 11 may be integrally incorporated within the headlight 13, for example. When the projection apparatus 11 is integrally incorporated within the headlight 13, the light source of the headlight 13 may also be used as the projection light source.

The projection apparatus 11 may be mounted, for example, at the rear of the vehicle body, and the image light from projection apparatus 11 may be projected onto the road surface behind the vehicle. Furthermore, the projection apparatus 11 may be mounted, for example, as a pair at the rear end of vehicle 2. Furthermore, the projection apparatus 11 may be integrally incorporated, for example, within the tail lights. When the projection apparatus 11 is integrally incorporated within the tail lights, the light source of the tail lights may also be used as the projection light source. The tail lights described above may also be brake lights or reverse lights, and subsequent mention of "tail lights" may be replaced with brake lights or reverse lights.

Furthermore, the controller 100 may control the tail lights and the projection apparatus 11 in coordination. For example, the controller 100 may true on the tail lights and cause the projection apparatus 11 to generate an image of the information to be displayed and project the image light toward the rear of the vehicle. Furthermore, controller 100 may, for example, turn off the tail lights and cause projection apparatus 11 to generate an image of the information to be displayed, project the image light toward the rear of the vehicle. That is, the tail lights and projection apparatus 11 may perform coordinated operation via controller 100.

On the other hand, the tail lights and projection apparatus 11 may operate without going through controller 100. For example, the tail lights and projection apparatus 11 may be connected, and the operation of the tail lights may be controlled by the projection apparatus 11 (specifically, the control unit of the projection apparatus 11). The projection apparatus 11 may, for example, turn on the tail lights, generate an image of the information to be displayed, and project the image light toward the rear of the vehicle. The projection apparatus 11 may also, for example, turn off the tail lights, generate an image of the information to be displayed, and project the image light toward the rear of the vehicle.

Additionally, the controller 100 may control the direction indicator lights and the projection apparatus 11 in coordination. For example, the controller 100 may turn on the direction indicator lights, cause the projection apparatus 11 to generate an image of the information to be displayed, and project the image light toward the front or rear of the vehicle's side. Furthermore, the controller 100 may, for example, turn off the direction indicator lights, cause the projection apparatus 11 to generate an image of the information to be displayed, and project the image light toward the front or rear of the vehicle's side. That is, the direction indicator lights and the projection apparatus 11 may perform coordinated operation via the controller 100. Moreover, the turning on and off of the direction indicator lights may be controlled by the driver's operation. The projection apparatus may be configured, for example, to project the image light toward the road surface on the side of the vehicle 2.

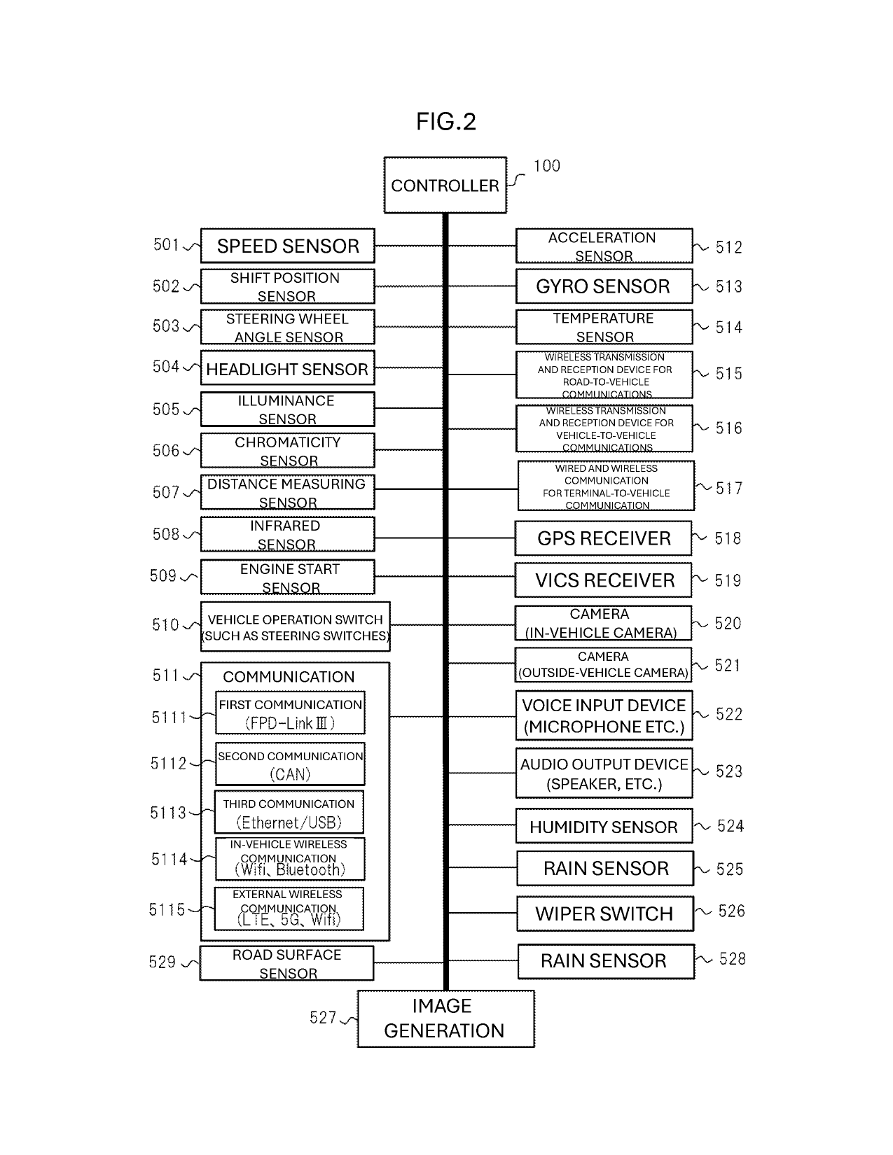

Information such as vehicle information 4 is acquired using devices such as cameras and various sensors. FIG. 2 shows an example of how the controller 100 connects to various devices. Furthermore, control units such as the projection apparatus 11, the in-vehicle video display apparatus 12, and the car navigation 150 can connect to the devices shown in FIG. 2 and directly acquire information without going through the controller 100. Regarding the various devices in FIG. 2, it is possible to delete them as appropriate, add other types of devices, or replace them with other types of devices.

The vehicle speed sensor 501 detects the speed of the vehicle 2 and is used to generate speed information, that is the detection result. The shift position sensor 502 detects the current gear and is used to generate gear information, that is the detection result. The steering wheel angle sensor 503 detects the current steering wheel angle and is used to generate steering wheel angle information, that is the detection result.

Headlight sensor 504 detects, for example, the ON/OFF state of headlight 13. Additionally, headlight sensor 504 may detect the brightness of headlight 13 when it is illuminated. The headlight sensor 504 is used to generate lamp illumination information, that is the detection results. The vehicle 2 may also be equipped with a high/low sensor that detects the state of the headlight 13 being high beam headlights or low beam headlights, and the high/low sensor is used to generate information indicating high beam headlights or low beam headlights. The vehicle 2 may also be equipped with a tail light sensor (not shown). The tail lights sensor detects, for example, the ON/OFF state of the tail lights. The tail lights sensor may also detect the brightness of the tail lights when it is illuminated. The tail lights sensor is used to generate lamp illumination information, that is the detection results. Similarly, sensors detecting the ON/OFF status and illumination brightness of brake lights, reverse lights, hazard lights, and direction indicator lights may also be provided, although not shown.

Illuminance sensor 505 and chromaticity sensor 506 detect external light around vehicle 2 and are used to generate external light information, that is the detection results. Additionally, chromaticity sensor 506 may detect the color of the road surface surrounding vehicle 2 and be used to generate projection surface color information, that is the detection results. Distance measuring sensor 507 detects the distance between vehicle 2 and external objects, or the distance between external objects themselves, and is used to generate distance information, that is the detection results. Infrared sensor 508 detects the presence and distance of objects in the vehicle's near vicinity and is used to generate infrared information, that is the detection results. Engine start sensor 509 detects the engine ON/OFF status and is used to generate ON/OFF information, that is the detection results.

Vehicle operation switch 510 refers to various switches operated by the driver or others, and is used to generate operation information such as ON/OFF status for these switches. Vehicle operation switch 510 relate to switches such as steering switches, on dashboard switches, vehicle door switches, armrest switches, and on center console switches.

The communication 511 is a configuration used for communication, including, for example, a first communication 5111, a second communication 5112, a third communication 5113, an in-vehicle wireless communication 5114, and an external wireless communication 5115.

The first communication 5111 is configured to perform communication by FPD-Link III, for example, and includes communication lines and communication devices used for FPD-Link III communication.

The second communication 5112 implements a communication protocol (CAN communication protocol) and includes communication lines and communication devices used for CAN communication.

The third communication 5113 is configured to perform communication by in-vehicle Ethernet, it implements an in-vehicle Ethernet communication protocol, and includes communication lines and communication devices used for communication by in-vehicle Ethernet. Note that, the third communication 5113 may include a USB (Universal Serial Bus) port, and the driver or others may connect devices (e.g., USB memory, devices with computer functions) to this port as appropriate. And, the third communication 5113 may perform communication by in-vehicle Ethernet, between the device connected to the port and the connection destination configuration.

The in-vehicle wireless communication 5114 is configured to communicate with in-vehicle information devices, implements communication protocols, and includes wireless devices. The in-vehicle wireless communication 5114 performs wireless communication using, for example, Wi-Fi (registered trademark) and Bluetooth (registered trademark). Note that, the in-vehicle wireless communication 5114, for example, may also perform short-range wireless communication, such as NFC (Near Field Communication).

The external wireless communication 5115 is configured to communicate with the exterior of vehicle 2, implements a communication protocol, and includes a wireless device. The external wireless communication 5115 performs wireless communication using, for example, LTE (Long Term Evolution), 5G, or Wi-Fi.

Note that, the configuration of communication 511 may be appropriately modified. Communication 511 may, for example, be configured to perform communication by LIN. Communication 511 may also, for example, be configured to perform communication by GSML.

Acceleration sensor 512 and gyro sensor 513 detect the acceleration and angular velocity of vehicle 2 and are used to generate acceleration-gyro information representing the vehicle's posture and behavior. Temperature Sensor 514 detects temperatures inside and outside the vehicle, on the road surface, etc., and is used to generate temperature information, that is the detection results.

The Wireless transmission and reception device for road-to-vehicle communications 515 generates road-to-vehicle communication information through road-to-vehicle communication between vehicle 2 and the road, signs, signals, etc. The Wireless transmission and reception device for vehicle-to-vehicle communications 516 generates vehicle-to-vehicle communication information through vehicle-to-vehicle communication between vehicle 2 and other surrounding vehicles. Wired and wireless communication for terminal-to-vehicle communication 517 is a device that acquires information by wired or wireless communication from equipment (e.g., Wi-Fi equipment) connected to the LTE network. Controller 100 or the control unit can acquire information transmitted and received over the LTE network, via the wired and wireless communication for terminal-to-vehicle communication 517.

GPS receiver 518 generates GPS information obtained by receiving GPS signals from GPS satellites. For example, by GPS receiver 518, it can acquire the current time, latitude, and longitude. VICS receiver 519 generates VICS information obtained by receiving VICS signals. Here, VICS signals include congestion information, weather information, etc., by radio beacons or optical beacons. GPS receiver 518 and VICS receiver 519 may be provided as part of a navigation system.

The in-vehicle camera 520 and the outside-vehicle camera 521 capture images inside and outside the vehicle, and are used to generate in-vehicle camera image information and outside-vehicle camera image information. Specifically, the in-vehicle camera 520 is, for example, a camera for a DMS (Driver Monitoring System) that captures the driver's posture, eye position, movements, etc. In this case, analyzing the captured images allows for the assessment of the driver's fatigue status and gaze position, etc.

Voice input device 522 receives the driver's voice and is used to generate voice information. The driver can input operation content via voice input device 522 by speaking. Audio output device 523 is a device that outputs audio processed by, for example, controller 100 or the control unit.

Humidity Sensor 524 detects humidity and is used to generate humidity information. Humidity Sensor 524 detects humidity outside vehicle 2 and on the road surface, and humidity information outside vehicle 2 may be generated. Furthermore, Humidity Sensor 524 detects humidity inside vehicle 2, and humidity information inside the vehicle may be generated.

Rain Sensor 525 detects raindrops and is used to generate rainfall information. Wiper Switch 526 detects the ON/OFF state of Wiper 6 and is used to generate Wiper 6 ON/OFF information. The direction indicator lights Switch (not shown) detects the driver's operation of the direction indicator lights and is used to generate direction indicator lights information.

The image generation 527 may generate image information based on information acquired from each sensor, or from the External device 25, or from the information terminal 26, or from the Internet, etc., may generate image information based on information acquired by the controller 100. Information other than vehicle information includes information from the external device 25 or the mobile device 26, or information from the Internet, etc. On the other hand, the image generation 527 may be omitted, in such a case, the controller 100 may be configured as the video generation function.

The rain sensor 528 detects the amount and size of raindrops. The rain sensor 528 can measure rainfall conditions by the amount of light entering the detector is decreased, by the presence of raindrops. The amount of raindrops detected by the rain sensor 528, may be used to generate related information such as the operating time of the wiper 6. Furthermore, the wiper 6's operating state may be changed in conjunction with the vehicle 2's running speed and the rain sensor 528's detection results, or it may be used to correct related information such as the wiper 6's operating time.

The road surface sensor 529 detects information regarding the road surface condition. The road surface sensor 529 may directly measure the wetness of the road surface or detect friction with the road surface. Alternatively, it may detect acceleration by the road surface condition and classify the road surface state from the acceleration waveform into states such as dry, semi-dry, wet, slush, fresh snow, compacted snow, ice, etc.

Controller 100 or the processor may, for example, transmit and receive data or information via wireless communication to acquire information necessary for driving. Controller 100 or the processor may also acquire information necessary for autonomous driving. Furthermore, controller 100 or the processor may, for example, transmit and receive data or information via wireless communication to perform data or information update processing. Controller 100 or the processor may perform updating, for example, such as various data or information (e.g., map data, data used for image processing, software, etc.), as update processing. Such technology is sometimes referred to as OTA (Over-the-Air) technology.

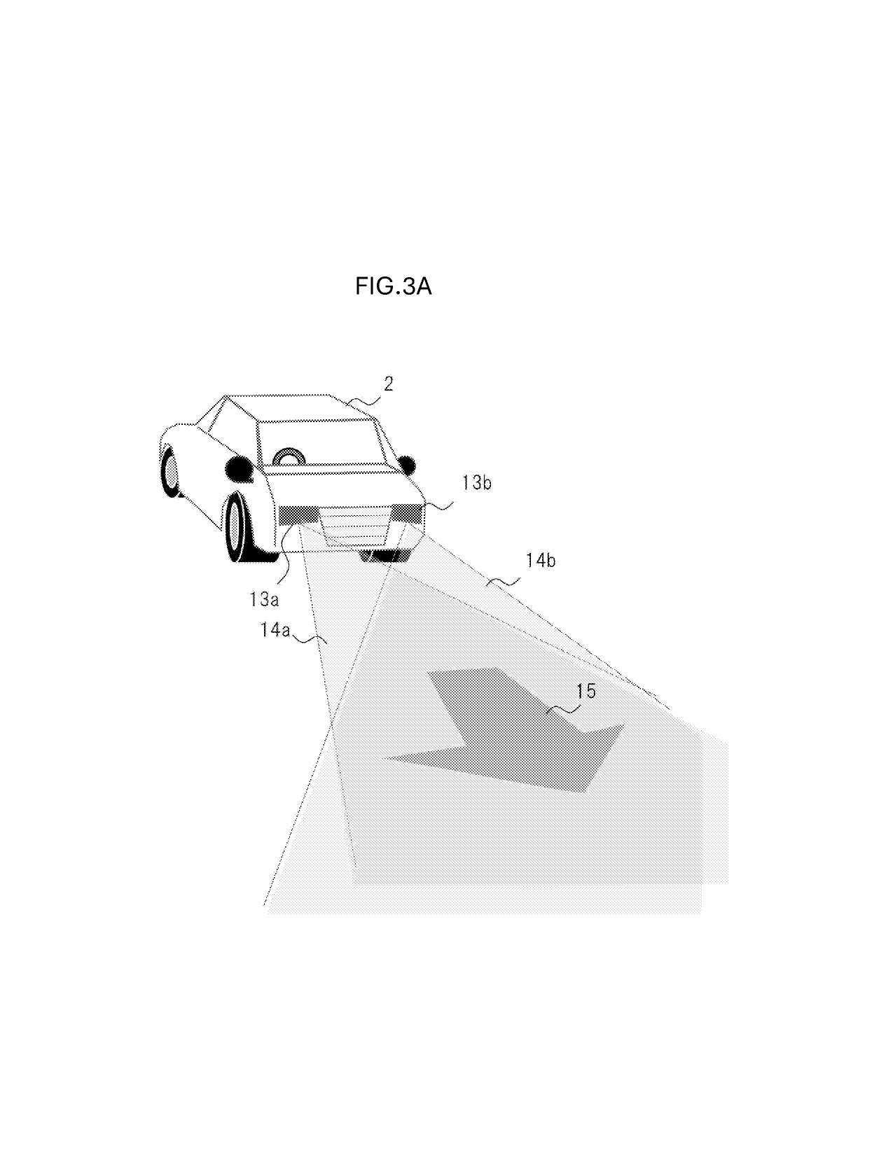

Next, referring to FIG. 3, an example of information projection by the projection apparatus will be described. As shown in FIG. 3A, image light is projected from the projection apparatus onto the road surface ahead, and in the figure, projection area 14a projected from projection apparatus 11 through the front right window section 13a of the vehicle 2, and projection area 14b projected from projection apparatus 11 through the front left window section 13b of the vehicle 2, are shown. The projected images of each projection area (14a, 14b) are combined to project an image (in this example, an arrow 15 that regarding of displaying vehicle 2 is traveling straight ahead) onto the road surface in front of vehicle 2. Note that in this example, the projection areas (14a, 14b) are divided left and right, but the projection areas may also be divided, for example, into areas near and far from the vehicle. Furthermore, image light may be projected using only one of the projection apparatus 11 installed on left and right side of the vehicle. In this example, the projection apparatus 11 is incorporated within the headlight 13, and the light source of the headlight 13 is utilized as the projection light source. However, as mentioned above, the placement of the projection apparatus 11 may be changed as appropriate. The projection apparatus 11 may have a light-emitting configuration different from that of the headlight 13, and the image light may be projected using the light emitted by this configuration.

As shown in FIG. 3B, image light is projected from the projection apparatus 11 onto the road surface behind the vehicle, in the figure, projection area 17a projected from the projection apparatus 11 on the rear right side of the vehicle and projection area 17b projected from the projection apparatus 11 on the rear left side of the vehicle, are shown. The projected images of each projection area (17a, 17b) are combined to project an image (in this example, an arrow 18 that regarding of displaying the vehicle is moving straight backward) onto the road surface behind the vehicle. Note that, in this example, the projection areas (17a, 17b) are divided left and right, but the projection areas may also be divided, for example, into areas near and far from the vehicle. Furthermore, image light may be projected using only one of the projection apparatus 11 installed on left and right side of the vehicle. In this example, the projection apparatus 11 is installed such that the light source of the tail lights can be utilized as the projection light source. However, as mentioned above, the placement of the projection apparatus 11 may be changed as appropriate. The projection apparatus 11 may have an illuminating configuration different from that of the tail lights, and the image light may be projected using the light emitted by this configuration

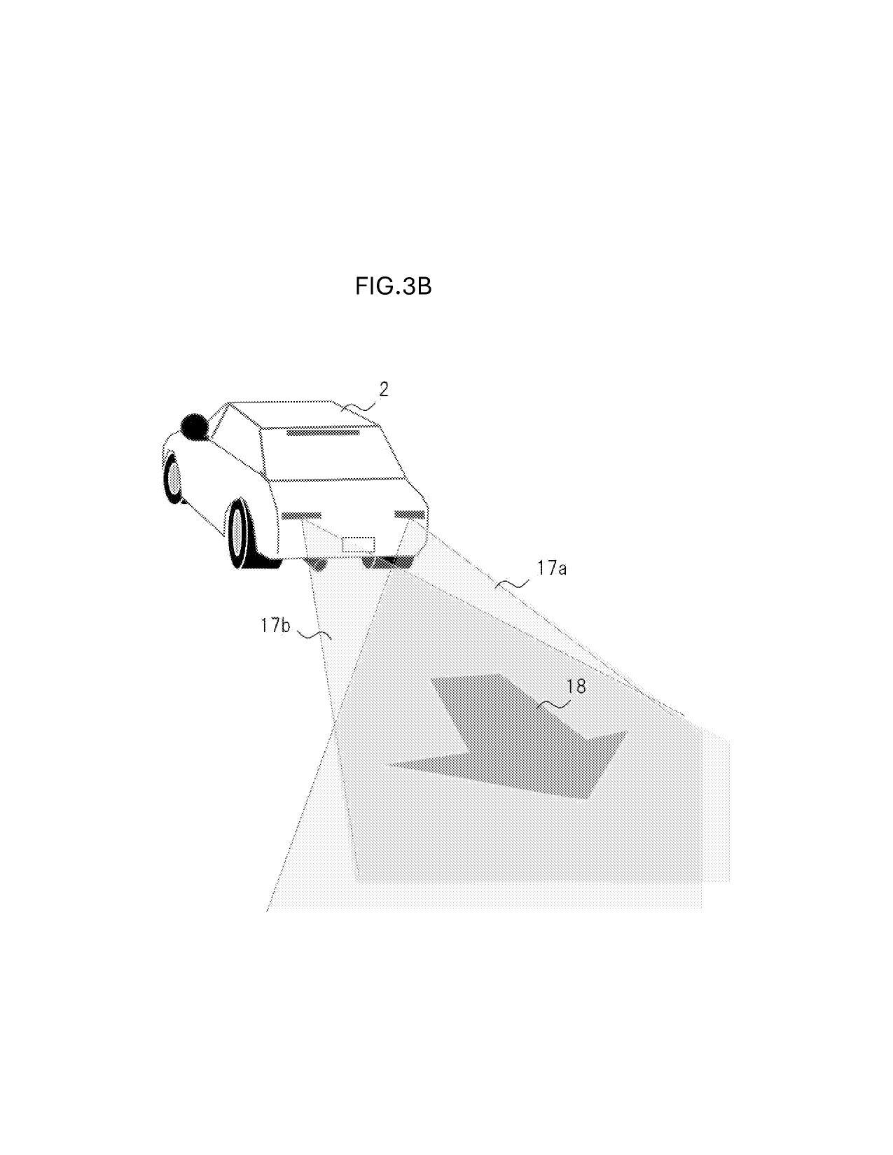

Referring to FIG. 4, an example configuration of the projection apparatus 11 is described. The projection apparatus 11 generates an image of the information to be displayed using data or information acquired, for example, via various sensors and a communication, and projects the image light. Note that, for example, data or information may be input to the projection apparatus 11 from the controller 100. Signal data, image data, etc., may be input to the projection apparatus 11 from the controller 100. The projection apparatus 11 may then process using the input information. Also, the controller 100 may be configured to control the projection apparatus 11 instead of the control unit of the projection apparatus 11. Furthermore, the control unit of the projection apparatus 11 and the controller 100 may perform processing in a divided manner, for example, the controller 100 may perform control to adjust the brightness of the headlight 13 and the brightness of the tail lights, while the control unit of the projection apparatus 11 may perform control to adjust the brightness of the projected image.

As shown in FIG. 4, the projection apparatus 11 includes a projection optical device 701 and a light source device 702. Furthermore, the projection apparatus 11 includes a power supply 703, a cooling device 704, an operation input unit 705, an image signal input unit 706, an audio signal input unit 707, an audio output unit 708, a communication 709, a non-volatile memory 710, a memory 711, a storage memory 712, an adjustment part 713, image controller or projection apparatus controller 714. Image controller or projection apparatus controller 714 may be configured as a processing device. Image controller or projection apparatus controller 714 can control the operation of projection apparatus 11. On the other hand, when control unit is not included, controller 100 can also control projection apparatus 11.

The projection optical device 701 is configured for projecting light. The projection optical device 701 includes optical components such as lenses and/or mirrors.

Light source device 702 is a device capable of generating image light. The light source device may use, for example, a high-pressure mercury lamp, a xenon lamp, an LED light source, a laser light source, etc., as the light source. Note that, the light source device may also include an optical element used for light focusing, uniformity, etc.

Power supply 703 supplies power to the light source, for example. Furthermore, power supply 703 supplies the necessary power to each of the other parts.

The cooling device 704 cools parts that become hot, such as the light source, power supply 703, or light source device 702, using air cooling and/or liquid cooling as needed.

The operation input unit 705, such as an operation button or a remote control receiver, inputs operation signals from the user. By inputting operation signals from the user, it switches the ON/OFF state of the switch (operation switch) that activates the projection apparatus 11.

The image signal input unit 706 is an interface device for acquiring image data from an external. The audio signal input unit 707 is an interface device for acquiring audio data from an external. The audio output unit 708 can, for example, perform audio output based on audio data input to the audio signal input unit 707. The audio output unit 708 may, for example, output operation sounds or error warning sounds.

The communication 709 is an interface device used for communication with the outside. The communication 709 is connected to an external information processing device (e.g., controller 100) and inputs/outputs various control signals. The communication 709 may also be connected to various sensors, communication devices installed in the vehicle 2, etc., and input/output various data or information.

Non-volatile memory 710 stores various data used, for example, in the projector function. The data stored in non-volatile memory 710 includes pre-prepared image data and video data for projecting images.

Memory 711 stores projected image data and control parameters for each part of device.

Storage memory 712 is a device that records video, images, audio, various data, etc. For example, video, images, audio, various data, etc., may be pre-recorded at the time of product shipment, and video, images, audio, various data, etc., acquired from an external device or an external server via communication 709 may be recorded. Furthermore, the image controller or projection apparatus controller 714 may acquire data or information updated from external via the communication 709, and update the recorded data or information to the new data or information. Additionally, by user selection, part or all of the recorded data or information may be updated to new data or information. The video, images, various data, etc., recorded in the storage memory 712 may be output as projected images. Audio recorded in the storage memory 712 may be output as audio from the audio output unit 708.

Adjustment part 713 is capable of adjusting the image light and includes, for example, an image adjustment part and a polarization adjustment part. The image adjustment part performs image processing on video data input in the image signal input unit, image data stored in non-volatile memory 710, or video data. This image processing includes, for example, scaling processing that performs image distortion correction, image enlargement, reduction, deformation, etc., brightness adjustment processing that changes image luminance, contrast adjustment processing that changes the image contrast curve (including adjustment of luminance gradation linearity characteristics), color correction processing that changes the image's chromaticity, and retinac processing that decomposes the image into light components (illuminant light component, reflected light component, ambient light component) and changes the weighting for each component. Note that, the image adjustment part is realized by the image controller or projection apparatus controller 714 storing data in memory 711 and executing image processing.

The polarization adjustment part adjusts the polarization degree of the projected image light. Here, the polarization degree refers to the ratio of the P-polarized light component to the S-polarized light component, which are the polarized light components contained in the light (P-polarization and S-polarization are defined relative to the projection surface). For example, the projection apparatus 11 includes a configuration capable of adjusting the polarization degree of the emitted light, such as the polarization separation element and polarization conversion element described later, and the image controller or projection apparatus controller 714 adjusts the polarization degree of the image light by controlling this configuration. Note that, the polarization control unit is realized by the image controller or projection apparatus controller 714 storing data (such as parameters used for control) in the memory 711 and controlling the aforementioned configuration. Also, multiple projection apparatus 11 with different polarization degrees may be provided and switched.

In the example of FIG. 4B, the light source device 702a comprises a light source 7021, a display element 7022, an optical element 7023, a polarization separation element 7024, and a polarization conversion element 7025. The light source 7021 generates light for image projection. Optical element 7023 is used for light focusing, uniformity, etc. Note that similar descriptions as above may be omitted. Polarization separation element 7024 is an element that separates incident light into S-polarized and P-polarized light. For example, polarization beamsplitters are used in polarization separation element 7024 to separate light by reflecting or transmitting light with a specific polarization state. The polarization conversion element 7025 is an element that converts the degree of polarization. For example, a waveplate is used in the polarization conversion element 7025, changing the polarization state by delaying the phase of the light. Here, for example, the polarization conversion element 7025 may be connected to an actuator (e.g., a motor) used to control the angle of incidence for transmission, and the adjustment part 713 or polarization adjustment part 722 in FIG. 4A, may adjust the incident light to the polarization degree according to the angle of incidence.

Furthermore, the projection apparatus 11 includes a display element and a display element driver. The display element is an element that modulates transmitted or reflected light to generate an image, such as a transmissive LCD (Liquid Crystal Display) panel, a reflective LCD panel, or a DMD (Digital Micromirror Device) (registered trademark) panel, etc., are used. The display element driver sends drive signals to the display element to generate an image on it. Display elements include configurations capable of displaying multiple images by control signals, such as DMD and LCD, as well as configurations that display only a fixed image, such as mask types.

In the example of FIG. 4C, the light source device 702b does not include a light source that serves as a backlight for the display element. In this example, the display element itself emits light. Note that, explanations similar to the above may be omitted.

The light source device 702b comprises a display light emitting element 7026, an optical element 7023, a polarization separation element 7024, and a polarization conversion element 7025. Display light emitting element 7026 is configured as a self-illuminating display, such as an LED array or an OLED (Organic Light Emitting Diode) display. Optical element 7023 is an optical system used for light focusing and uniformity. Note that, optical element 7023, polarization separation eleme ent 7024, and polarization conversion element 7025 are the same as described in FIG. 4B.

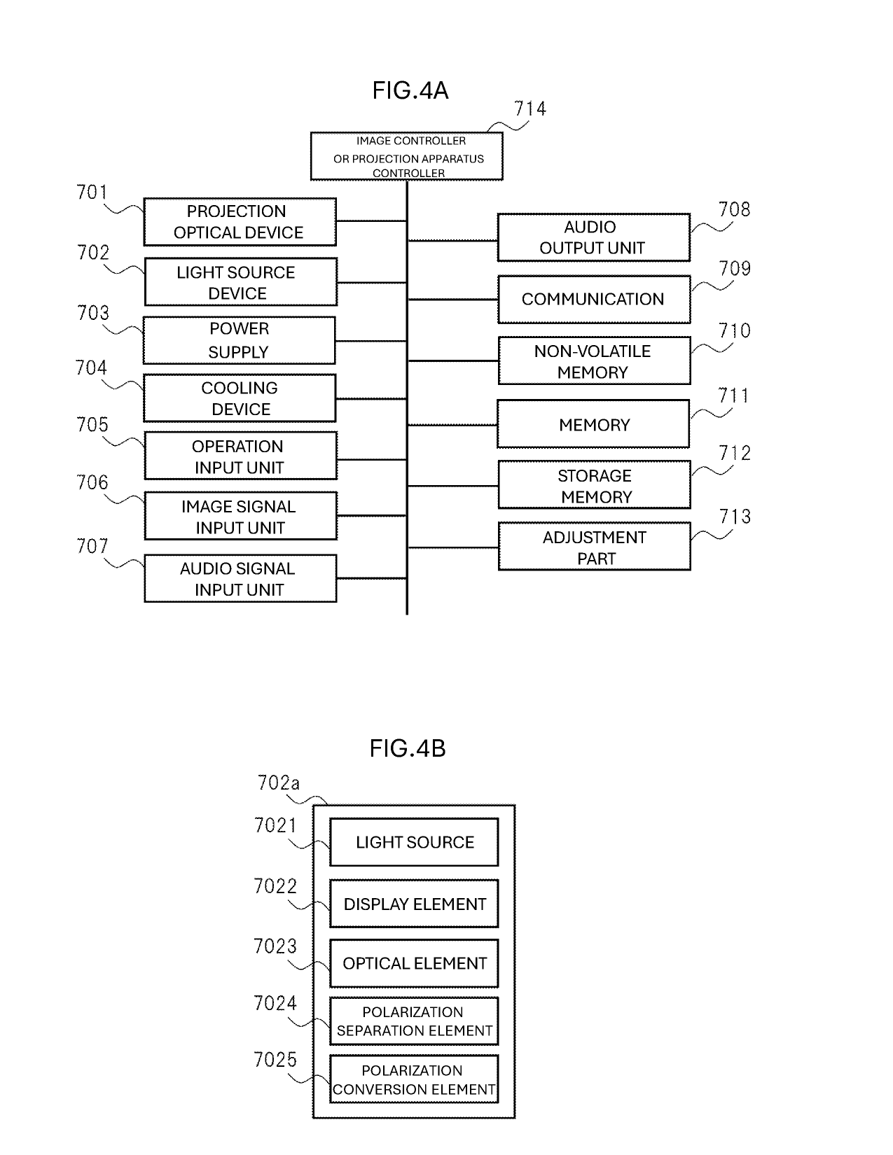

Next, referring to FIG. 5, we will explain an example of the arrangement of optical components and other parts. FIG. 5A shows an example using a reflective display element, projecting an image using a DMD method. The first optical element 901 is an optical element that collimates light generated by the light source 900, such as a collimator. The second optical element 902 is a mirror that projects the collimated light onto the display element 907. In this example, the display element 907 is configured as a DMD-type panel, and light projection is adjusted or controlled for each display pixel. The third optical element 903 is configured to project image light and is constructed using optical components such as lenses or mirrors. A reflective LCD panel may also be used as the reflective display element.

FIG. 5B shows an example that the display light emitting element 908 itself emits light to project an image. The display light emitting element 908 is configured as an LED array panel or an LED matrix panel, and the image is generated by the combination of the lighting positions and lighting colors of the LEDs on the panel. The fourth optical element 904 is configured to project the image light and is constructed using optical components such as lenses or mirrors. For the display light emitting element, an OLED display may be used instead of the above-mentioned panel.

FIG. 5C shows an example that light is transmitted through the display element 909 to display an image. The fifth optical element 905 is the same as the first optical element 901 described above. The display element 909 is, for example, a transmissive LCD panel, and an image is generated on the display element 909. The sixth optical element 906 is configured to project image light and is constructed using optical components such as lenses or mirrors. Note that, the display element 909 may be configured with a mask forming a predetermined pattern positioned on the light source side. In this case, by light passing through the mask without being obstructed by the mask which is the display element, it can display a fixed image based on the pattern formed on the mask. Additionally, the display element 909 may be configured with a lens having a predetermined pattern placed on the light source side. In this case, the display element 909 can display a fixed image based on the pattern formed on the lens. Note that, the predetermined pattern formed on the lens is formed either on the lens surface or inside the lens, and the pattern formed partially blocks light transmission, or partially transmits light. The lens used in display element 909 may be a microlens array. In that case, the pattern formed on each lens is different.

Note that, the light source shown in FIGS. 5A and 5C may be configured by the light source of the projection apparatus 11, but may also be the light source of the headlight 13 or the tail lights. In this case, the light source of the projection apparatus 11 may be omitted. On the other hand, the light source shown in FIGS. 5A and 5C may also be configured as a combination of the light source of the projection apparatus 11 and the light source of the headlight 13 or the tail lights. Furthermore, the light source of the projection apparatus 11 may be configured with one or multiple. Similarly, the display element corresponding to the light source may also be one or multiple.

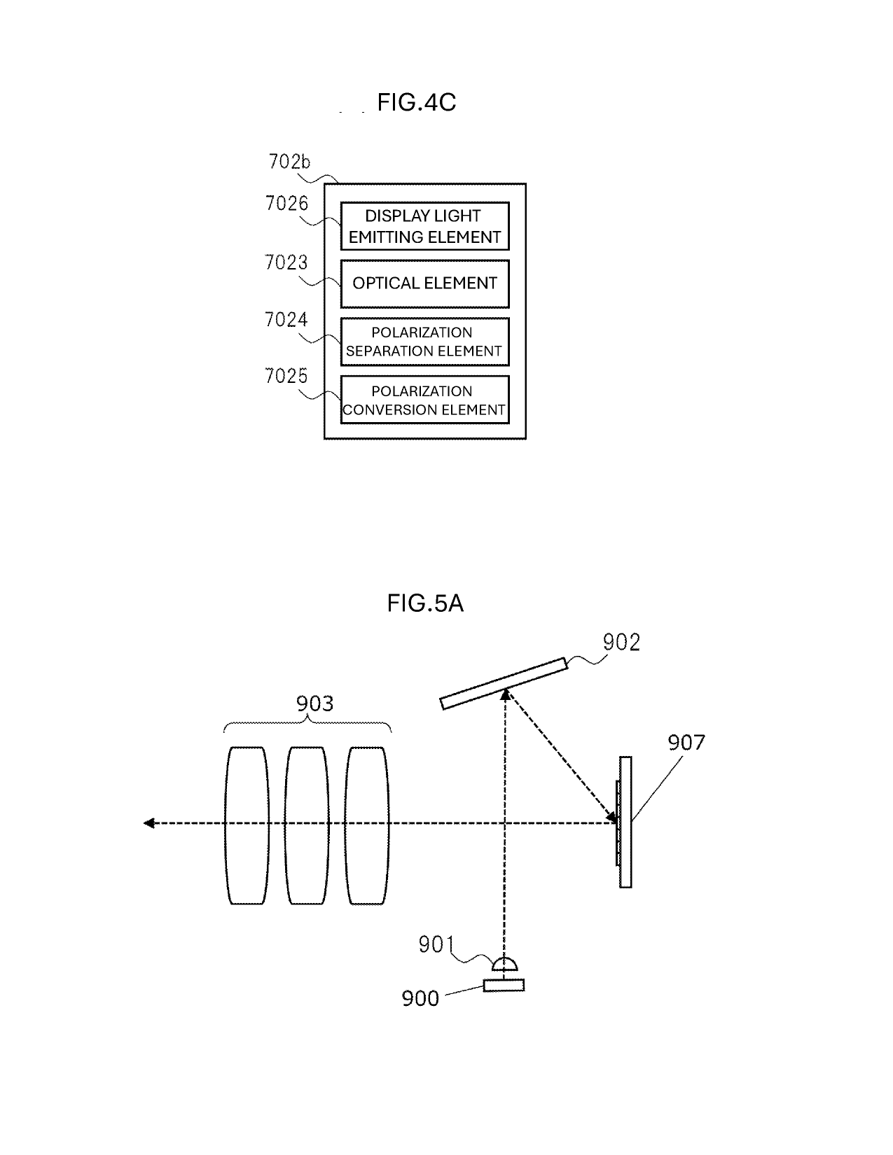

Next, referring to FIG. 6, an example of the display area for the image seen by the driver is described. FIG. 6 shows the illumination area A1 for the high beam headlights of headlight 13, the illumination area A2 for the low beam headlights of headlight 13, and the image area A3 for the road surface image projected by the projection apparatus 11. In the upper illumination area of the high beam headlights, the high beam headlights where high positioned, is illuminated. That is, it is possible to emit high beam headlights that illuminate the distance brightly, in this illumination area. In the lower illumination area of the high beam headlights, the high beam headlights where low positioned, is illuminated, since this area overlaps with the projection area of the low beam headlights, the low beam headlights may sometimes be formed by shading part of the illumination area of headlight 13 where the high beam headlights can be projected. Furthermore, the image projection area A3 projected by the projection apparatus 11 is contained within the illumination area A2 of the low beam headlights and the illumination area where lower illumination area A1 of the high beam headlights. Therefore, the projection apparatus 11 can also project images using the low beam headlights and high beam headlights of the headlight 13, and the projection apparatus 11 may be provided separately from the headlight 13.

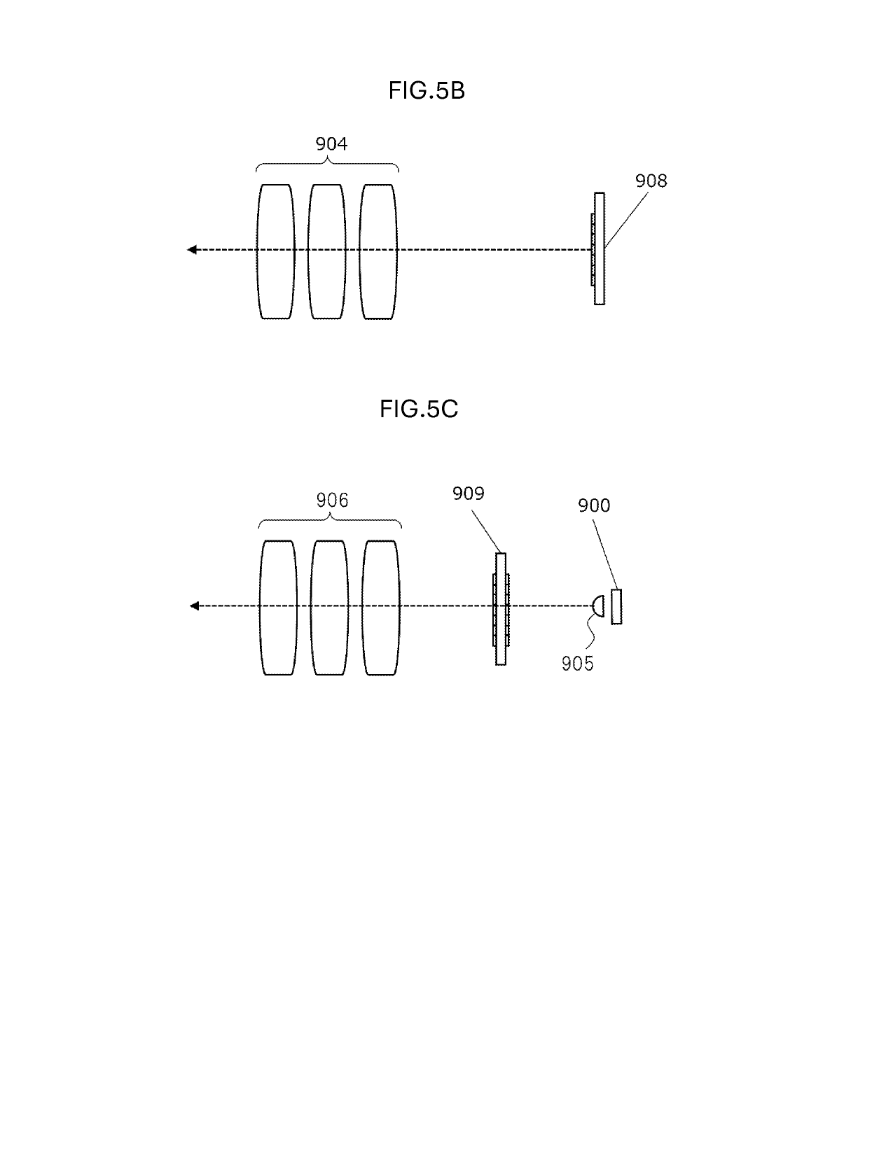

Referring to FIG. 7, an example of the projection areas around the vehicle is described. FIG. 7 shows a vehicle front road surface display area A11, a vehicle rear road surface display area A12, and vehicle left/right road surface display areas A13. The vehicle front road surface display area A11 is a display area formed on the road surface ahead, referenced to the position of the vehicle itself, and the projection apparatus 11 may be configured, for example, to project image light into this area to display information. The vehicle rear road surface display area A12 is a display area formed on the road surface behind the vehicle relative to the vehicle's position, and the projection apparatus 11 may be configured, for example, to project image light onto this area to display information. The vehicle left/right road surface display area A13 is a display area formed on the left and/or right road surface relative to the vehicle's position, and the projection apparatus 11 may be configured, for example, to project image light onto this area to display information. This area A13 may be made a visible area for information displayed by vehicles and persons (such as pedestrians) around the vehicle.

Next, an example of projection control for the projection apparatus 11 is described. For example, when it rains, the light from the lights is scattered by raindrops, and the reflectivity of the road surface changes, increasing the specular reflectivity, this causing the light from the lights to reflect off the road surface and glare for surrounding people and vehicles. Therefore, a projection control capable of suppressing glare for surrounding people and vehicles is described. Note that, currently, while standardization including performing turning off or dimming the projection apparatus 11 when the wiper operates continuously for at least two minutes, is under discussion, it has not yet been finalized.

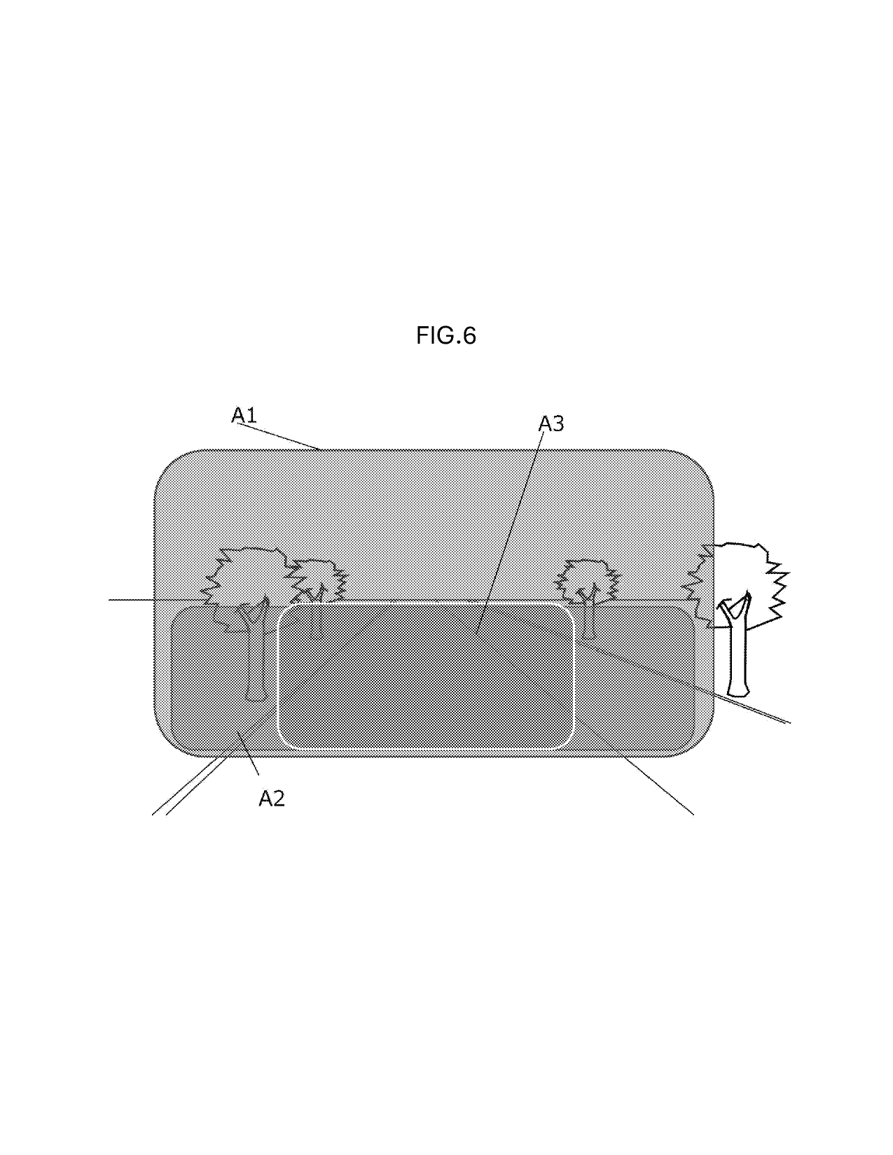

FIG. 8 shows an example of this control flow. Note that, the main entity performing the control described here is the processor (the processor of the information projection apparatus). The processor is configured, for example, using the image controller or projection apparatus controller 714 of the projection apparatus 11. However, this is not limited to this, and the processor may also be configured using, for example, other semiconductor devices such as an ECU, the controller 100 of the vehicle 2, or the control device of the external device, etc.

As shown in FIG. 8, processing begins (S1), and the processor performs a projection start determination (S2). Then, in S2, for example, if conditions described later are satisfied, the processor acquires vehicle-related information from the vehicle or an external device 25, etc., used in the determination in S4 (S3). Here, the receiver of the projection apparatus 11 acquires the vehicle-related information from the vehicle or the external device 25, etc. In this embodiment, the communication 709 described in FIG. 4A may acquire information from the various sensors described in FIG. 2. Alternatively, communication may be performed with the vehicle's external via the communication device of the in-vehicle system 300, and the acquired information may be obtained by the communication 709. The communication 709 may function as a receiver or as a transmission/reception unit. The processor then determines a projection control method (S4) and performs projection of the projection apparatus 11 based on that result (S5). Subsequently, the processor determines the end of projection (S6), causes the projection apparatus 11 to terminate projection based on that result (S7), and the processing ends (S8).

In S3, information acquisition is performed at least one of wiper operation information acquisition (S31) and rain sensor information acquisition (S32). Note that, in S3, for example, in addition to wiper operation information acquisition (S31) and rain sensor information acquisition (S32), road surface sensor information acquisition (S33) may be performed, and road surface sensor information acquisition (S33) may be performed instead of wiper operation information acquisition (S31) and rain sensor information acquisition (S32).

Furthermore, if projection termination is not determined in S6, the control return to S3 may be performed. Alternatively, control repeating the processing from start (S1) to end (S8), may be performed. Additionally, if non-projection is determined in S2 and S4, processing at S8 may be performed, and the process may terminate.

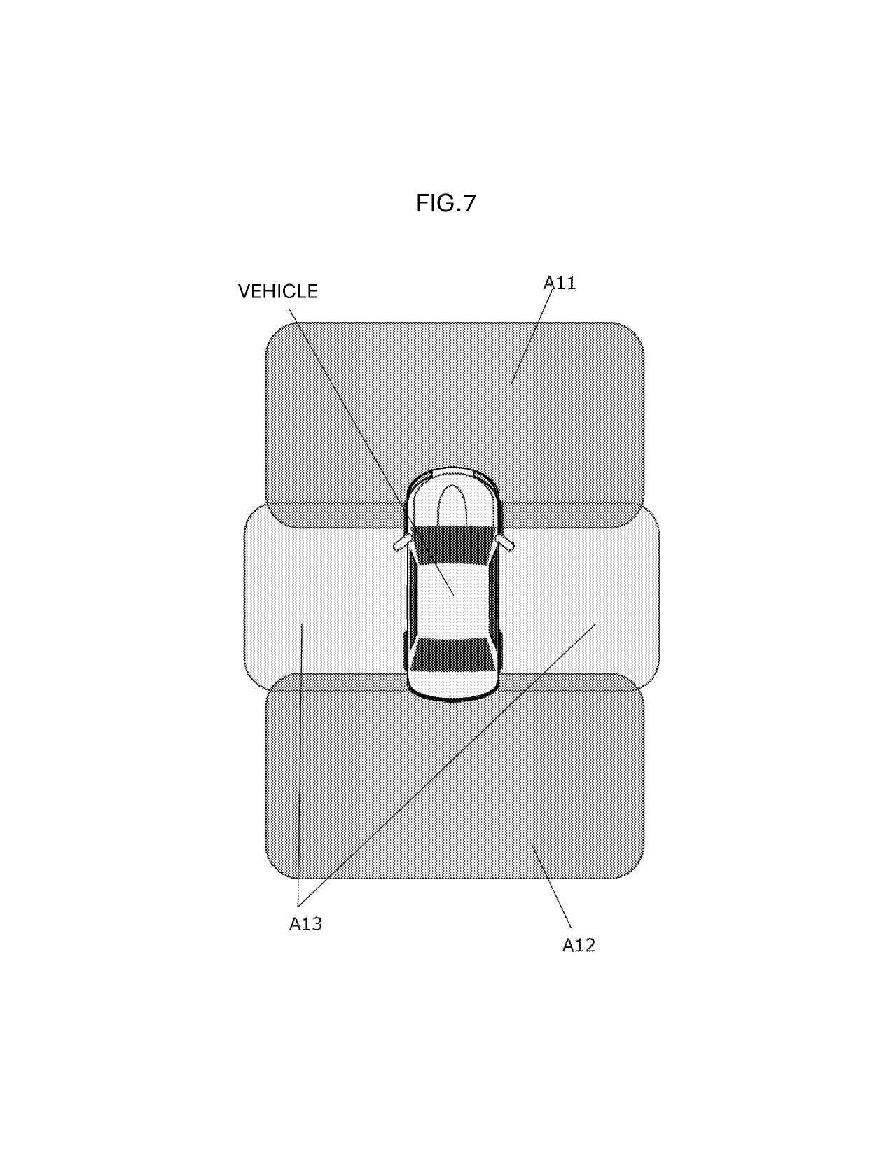

Next, referring to FIG. 9, an example of processing in S4 is described. The processor determines whether the wiper 6 setting is automatic control or manual control (S4a). If the processor determines the wiper 6 setting is automatic control, it determines whether the continuous wiping time of wiper 6 is equal to or greater than a specified time (S4b). Then, based on the result of the determination in S4b, the processor controls the projection in the mode described later. Note that, the continuous wiping time information of wiper 6 is information regarding the continuous wiping time of wiper 6. This continuous wiping time of wiper 6 may be the time from when wiper 6 starts wiping until it stops (i.e., the time from when the wiper 6 switch turns ON until it turns OFF).

If the processor determines that wiper 6 is set to manual control, it determines whether the continuous wiping time of wiper 6 is equal to or longer than a specified time (S4c). If the processor determines that the continuous wiping time of wiper 6 is not equal to or greater than the specified time, it determines whether the time during which the output level of rain sensor 528 is at or below the specified value is equal to or greater than the specified time (S4d). Based on the results of determinations S4c and S4d, the processor then controls the projection in the mode described later.

Note that, during automatic control, wiper 6 operates based on the output of rain sensor 528. Specifically, the detected light amount of rain sensor 528 changes depending on the amount of water droplets adhering to windshield 3. Therefore, when the detected light amount is high, it is determined that rainfall is light, causing wiper 6 to stop or to intermittent wiping, when the detected light amount is low, it is determined that rainfall is heavy, causing wiper 6 to continuous wiping. Thus, since the output of rain sensor 528 and the operation of wiper 6 are correlated, it is sufficient to check either the time variation of the rain sensor 528 output value or the continuous wiping time of wiper 6. Therefore, in S4b, instead of determining whether the continuous wiping time of wiper 6 is longer than a specified time, it is also possible to determine whether the time during which the output level of rain sensor 528 is below a specified value is longer than a specified time. Here, the processor may, for example, initiate projection (S5) when the output level of rain sensor 528 is at or above the specified value, or when the time during which the output level of rain sensor 528 is at or below the specified value is less than the specified time, and the processor may terminate projection (S7) when the time during which the output level of rain sensor 528 is at or below the specified value is equal to or longer than the specified time. On the other hand, during manual control, activation of wiper 6 is left to the user's judgment, and the operating state or operating time of wiper 6 does not necessarily correspond to the surrounding rainfall conditions. Therefore, since the operation of rain sensor 528 and wiper 6 are not necessarily linked, confirming both conditions of rain sensor 528 and wiper 6 operation allows for accurate recognition of rainfall conditions. Furthermore, if rain sensor 528 is not installed and the wiper 6 settings do not include automatic control, it may suffice to determine only whether the continuous wiping time of wiper 6 exceeds a specified time value. In this embodiment, rain sensor 528 detects reflected light when LED light is reflected off windshield 3. The maximum detection value occurs when no water droplets are present on windshield 3, and since the refractive index of water 1.33 is higher than that of air 1.00, when water droplets adhere, causing the light path to change and the detection value to decrease. The above example describes a case where the output level from the rain sensor 528 decreases when its detection value decreases. However, it may also be configured such that the output level from the rain sensor 528 increases when the detection value decreases. In that case, the relationship with the specified value must be reconfigured in the opposite manner, depending on whether the output level decreases or increases with rainfall.

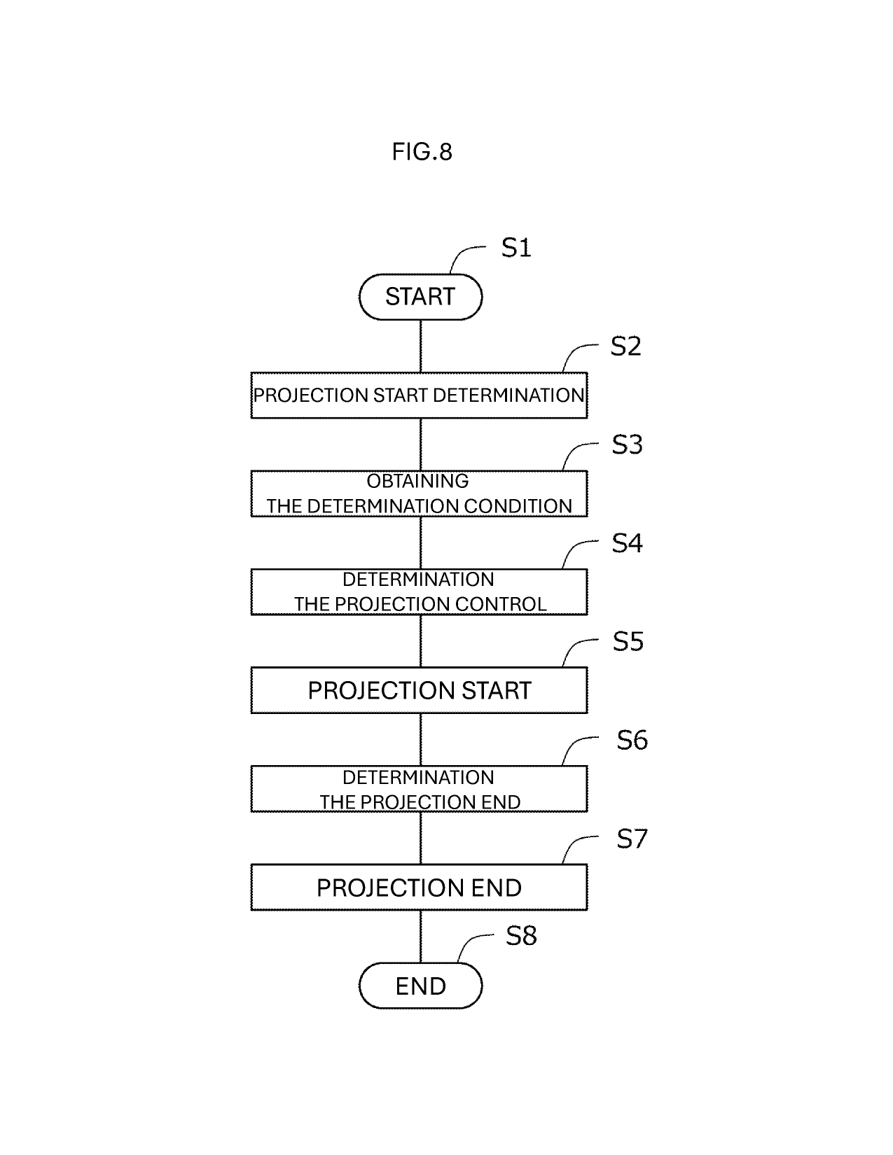

Next, referring to FIG. 10, an example of the projection start determination (S2) is explained. When the processor acquires information that the direction indicator lights 14 are illuminated (i.e., acquires information that the switch to illuminate the direction indicator lights 14 is ON), it performs the processing of S3 (Example 1).

The processor acquires information that the direction indicator lights 14 are lit (i.e., acquires information that the switch to turn on the direction indicator lights 14 is ON), and if permission is granted to project information corresponding to the information of direction indicator lights 14 onto the road surface, it performs the processing in S3 (Example 2). On the other hand, if permission to project information corresponding to the information of direction indicator lights 14 onto the road surface is not granted, processing proceeds to S7 (Example 3). The user can choose whether or not to use information projection corresponding to information of the direction indicator lights 14 onto the road surface. Therefore, it detects the user-defined setting information or the state of the usage selection switch to determine whether to project onto the road surface when the direction indicator lights 14 are illuminated.

The processor acquires information that the direction indicator lights 14 are lit (i.e., acquires information that the switch to light the direction indicator lights 14 is ON), and if projection of other higher-priority information is not permitted, it performs the processing in S3 (Example 4). On the other hand, if projection of other higher-priority information is permitted, processing proceeds to S7 (Example 5). When information other than that corresponding to information of the direction indicator lights 14 is displayed on the road surface, multiple pieces of information may overlap, making it difficult to correctly recognize the information. Furthermore, even if multiple pieces of information do not overlap, focusing on another information can make it difficult to simultaneously recognize all displayed pieces of information. Therefore, it is desirable to limit the displayed information to that with a high priority. In this case, the number of images that can be displayed simultaneously may be specified.

Additionally, if the processor does not acquire information that the direction indicator lights 14 are illuminated (i.e., if it acquires information that the switch to illuminate the direction indicator lights 14 is OFF), the process proceeds to step S7 (Example 6). The projection of information for the direction indicator lights 14 is required to be synchronized with the lighting of the direction indicator lights 14. Therefore, if the information that the direction indicator lights 14 have lit cannot be confirmed, the projection of information for the direction indicator lights 14 is not performed, and the projection process is terminated.

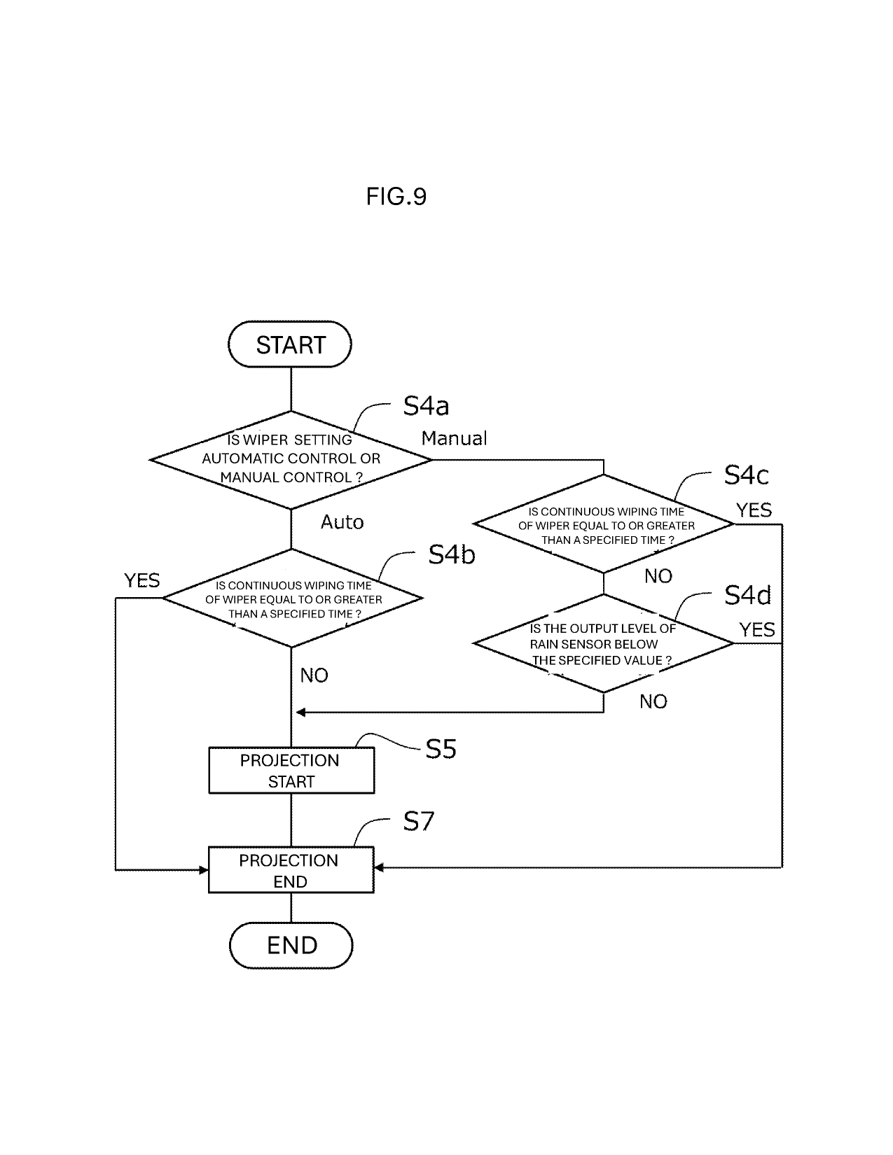

Next, referring to FIG. 11, an example of the lighting modes of projection apparatus is explained. The normal projection mode is a mode that projects images in a normal state without flashing, dimming, etc. (Example 1). The dimmed projection mode is a mode that projects dimmed images (Example 2). The projection stop mode is a mode that does not perform projection regardless of the result of the projection start condition (Example 3).

Projection apparatus 11 can project information of direction indicator lights 14, and can also project information (e.g., the vehicle's direction of travel) other than that information of direction indicator lights 14. In this control example, the processor performs projection control in one of these modes, for example, based on the determination result in S4. Furthermore, the priority of the projected information can be set for each of information. Additionally, projection permission for the information can be set for each of information.

The priority of projected information and projection permission can be preset by the driver or others, for example. Settings may be made using the operation input unit 705, or presets established during manufacturing may be used.

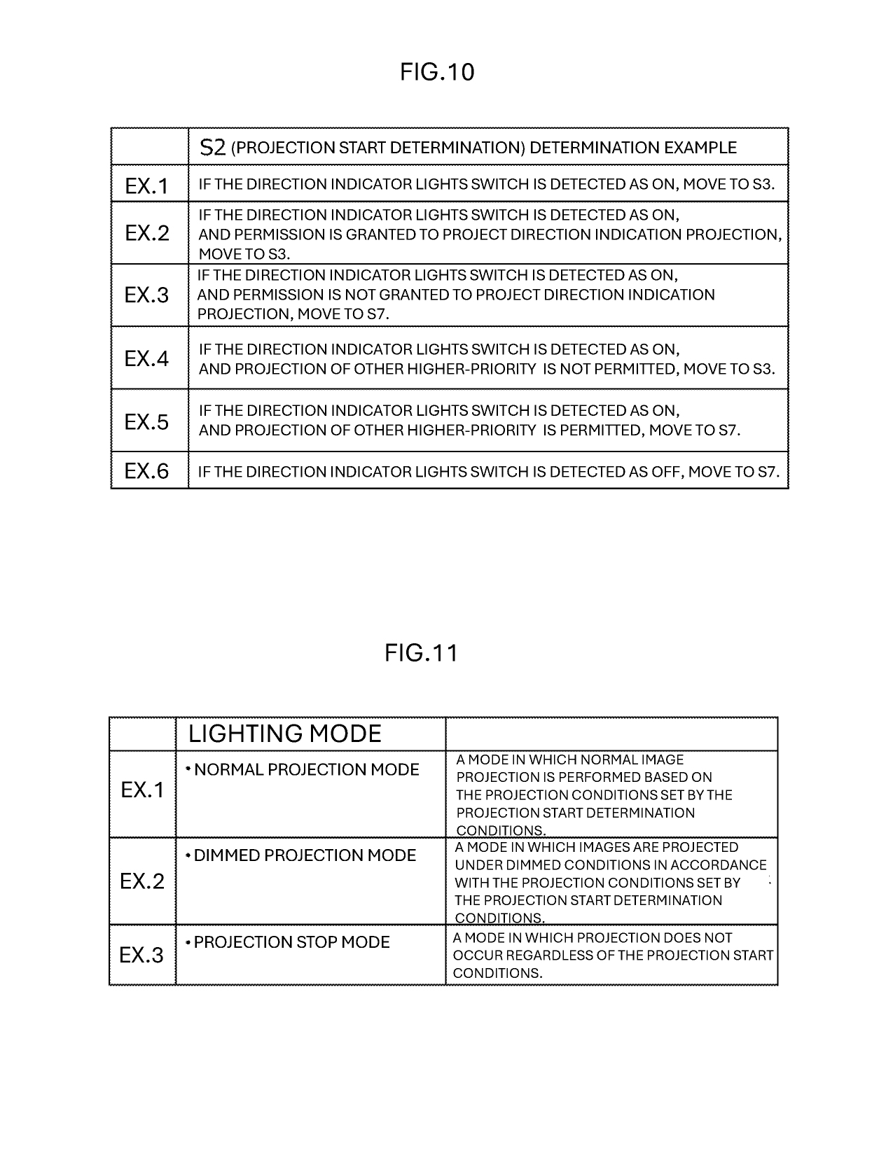

Next, referring to FIG. 12, an example of the acquired information in S3 is described. In wiper operation information acquisition (S31), the processor may acquire wiper operation setting information based on vehicle information 4. The wiper operation setting information is information concerning the operation of the wiper 6, such as information indicating whether the wiper 6 operation is manual control or automatic control. The processor may also acquire wiper operation status information based on the vehicle information 4. The wiper operation status is information concerning the current operating state of the wiper 6 (e.g., wiper off, intermittent wiping, low speed wiping, high speed wiping, single wipe, etc.). The processor may also acquire wiper continuous wiping time information based on vehicle information 4. Wiper continuous wiping time information is information regarding the continuous wiping time of wiper 6. Wiper continuous wiping time information may be recorded for each wiper operation state. The processor may also acquire information regarding the ejection of windshield washer fluid.

Rain sensor 528 can detect the amount of raindrops adhering to the windshield 3. When there are many raindrops, the light entering the detection element of rain sensor 528 decreases, resulting in a low detection level. When there are few raindrops, the light entering the detection element of rain sensor 528 increases, resulting in a high detection level, thereby detecting the amount of raindrops. During rain sensor information acquisition (S32), the processor may acquire information about rain sensor 528 based on vehicle information 4. The processor may acquire information such as the detection sensitivity of rain sensor 528, the detection signal level of rain sensor 528, and information regarding the temporal variation of the signal level of rain sensor 528. The processor may also acquire speed information based on vehicle information 4. Furthermore, the processor may acquire information regarding the ejection of windshield washer fluid.

During road surface sensor information acquisition (S33), the processor may acquire information of road surface sensor 529 based on vehicle information 4. The processor may acquire, for example, the detection sensitivity of road surface sensor 529, acceleration information, road surface friction information, road surface wetness information, and road surface condition information (e.g., dry, semi-dry, wet, slush, fresh snow, compacted snow, ice). Changes in road surface reflectivity during rainfall cannot be accurately estimated using only information from the wiper 6 and/or rain sensor 528. In reality, it is also influenced by the actual road surface condition. It differs between asphalt roads and unpaved roads, and even on the same asphalt road, it varies due to differences in drainage. In such cases, using a road surface sensor 529 mounted on tires, etc., enables direct detection of the road surface condition.

Here, the road surface sensor 529 is mounted on vehicle 2 and used to acquire road surface information. As one example, the road surface sensor 529 may be configured by installing inside the tire a sensor module that measures acceleration, temperature, pressure, etc., a wireless communication device that transmits the sensing results, and a small generator that supplies power to operate these components. Furthermore, since the sensing results during travel produce characteristic waveforms corresponding to the road surface condition, analyzing these sensing results enables identification of the road surface condition. Note that, such as the vehicle's controller 100, a processor controlling projection apparatus 11, may also acquire and analyze the sensing results. For this analysis, a machine learning model that estimates the road surface condition based on the input sensing results may be used, for example. Furthermore, this analysis may be performed using known statistical methods. Road surface conditions may be detected using methods other than the road surface sensor 529. For example, the reflectivity change of the road surface may be measured by detecting the road surface illuminance from the headlights using a vehicle camera (external camera 521), thereby determining the wetness state of the road surface.

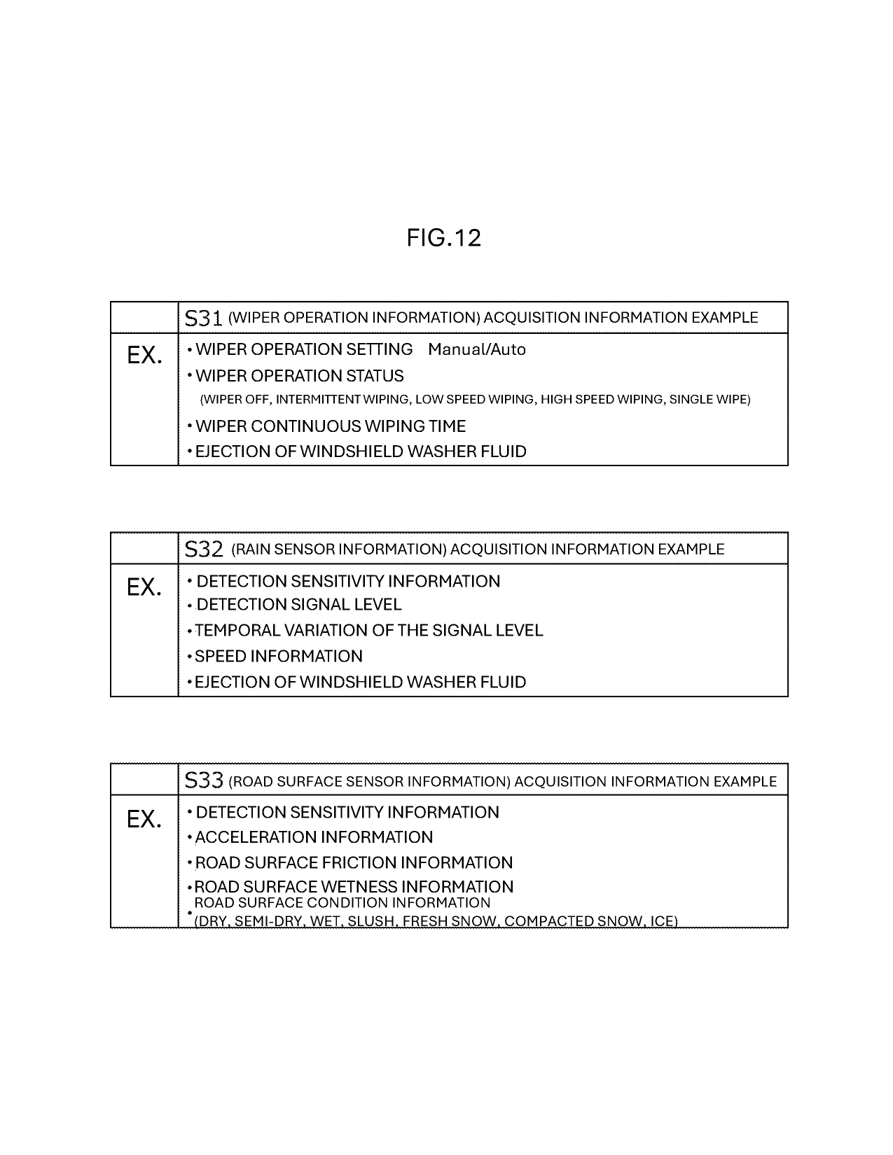

Next, referring to FIG. 13, an example of the determination in S4 is explained. The processor determines which of the prerequisites applies based on the information acquired in S3. Hereinafter, an example of the determination based on whether the projection apparatus 11 is in the off state or the on state before the wiper 6 operates. This example describes cases based on the wiper 6 operation mode, the presence or absence of the wiper 6 and rain sensor 528, and a case comparing the wiper 6 operation mode with the output of the rain sensor 528.

First, we describe the case where the prerequisite that state of the projection apparatus 11 being in the off is condition A. A c haracteristic of condition A in this embodiment is that it considers only the continuous wiping time of wiper 6. For example, an instance of condition A is when the operation setting of wiper 6 is automatic control. In this case, the wiper 6's operational state is linked to the output of the rain sensor 528. Therefore, the wiper 6 operates according to the rainfall amount, and the continuous wiping time of the wiper 6 directly reflects the rainfall amount. Another example of condition A is when the wiper 6's operation setting is manual control and the vehicle 2 does not have a rain sensor 528. Under this condition, since there is no means to directly detect rainfall, the only way to determine rainfall is by the continuous wiping time of wiper 6. Another example of condition A is when the output value of rain sensor 528 matches the operation of wiper 6. Even when rain sensor 528 is present, there are times when linked operation does not occur, such as when the operation mode is set to manual control. In such cases, comparing the output value of rain sensor 528 with the operational state of wiper 6 allows confirmation whether the continuous wiping time of wiper 6 directly reflects rainfall or exhibits different behavior relative to rainfall. If the comparison confirms the operation correctly reflects rainfall, the continuous wiping time of wiper 6 can be used for determination.

The processor performs projection control based on the normal projection mode when it acquires information that wiper 6 is operating intermittently (example 1). Furthermore, the processor performs projection control based on the normal projection mode when wiper 6 is continuous wiping and the continuous wiping time of wiper 6 is less than a specified time (example 2). In Examples 1 and 2, since the wiper 6 operation information indicates low rainfall and no increase in road surface reflectivity, projection is not restricted.

The processor performs projection control based on the dimmed projection mode or projection stop mode when wiper 6 is continuous wiping and the continuous wiping time of wiper 6 is equal to or longer than a specified time (example 3). In example 3, based on wiper 6 operation information, it is determined that rainfall is heavy and road surface reflectivity has increased, so projection is restricted. Note that, in cases corresponding to example 3, whether to perform dimmed projection mode or projection stop mode as the projection restriction is preset. For example, the driver may preset this using operation input unit 705.

Examples 4 and 5 are examples using multiple thresholds (first specified time and second specified time). The thresholds may be preset or automatically set based on vehicle information. The processor performs projection control based on the dimming projection mode when wiper 6 is continuous wiping, the continuous wiping time of wiper 6 is at least the specified time 1, and is less than the second specified time, which is greater than the first specified time (example 4). Furthermore, the processor performs projection control based on the projection stop mode when wiper 6 is continuous wiping and the continuous wiping time of the wiper is at least the second specified time (example5). In example 4, it is determined that, although the rainfall amount is high based on wiper 6 operation information, the operation time information indicates that the road surface reflectivity has not increased, so the projection restriction is set low. In this example, the projected light is dimmed. Furthermore, in Example 5, it is determined that, the rainfall amount is high based on wiper 6 operation information, and the operation time information indicates that the road surface reflectivity has increased, so the projection restriction is set high. In this example, projection is stopped.

Furthermore, as described above, during automatic control, the output of the rain sensor 528 and the operation of the wiper 6 are considered to be linked. Therefore, it is sufficient to check only one of the rain sensor 528 or continuous wiping time of the wiper 6. Consequently, although not shown, the processor may perform projection control based on the output of the rain sensor 528 instead of the continuous wiping time of the wiper 6. For example, when the rain sensor output value is at or above a specified value, projection control based on the normal projection mode may be performed. When the rain sensor output value is below the specified value, projection control based on either the dimmed projection mode or the projection stop mode may be performed, depending on whether the time below the specified value exceeds a specified time. Also, a first specified time and a second specified time may be set, and projection control may be performed that switches between the dimmed projection mode and the projection stop mode based on the time below the specified value.

Next, we describe the case where the prerequisite that state of the projection apparatus 11 being in the off is condition B. A characteristic of condition B is when the information of the wiper 6 and the rain sensor 528 does not match. For example, condition B includes cases where the wiper 6 operation setting is manual control and the vehicle 2 is equipped with a rain sensor 528. In this case, since wiper 6 operation is left to the user, the operational state varies by user. Therefore, compared to when the operation setting is automatic control, the continuous wiping time of wiper 6 may be shorter or longer, or it may not be in continuous wiping. Another example of condition B is when the output value of rain sensor 528 does not match the wiper 6 operation. Under condition B, projection control using the output value of rain sensor 528 is performed, regardless of the continuous wiping time of wiper 6.

The processor performs projection control based on the dimmed projection mode or projection stop mode when the output value of the rain sensor 528 is below a specified value, even if the continuous wiping time of the wiper 6 is less than the specified time (example 6). Specifically, projection control based on the dimmed projection mode or projection stop mode is performed when the time during which the output value of rain sensor 528 is at or below the specified value is equal to or longer than the specified time, regardless of the operating time of wiper 6. Note that, in cases corresponding to example 6, whether to perform the dimmed projection mode or the projection stop mode is preset. For example, the driver may preset this using operation input unit 705. Furthermore, projection control may be performed by switching between the dimmed projection mode and the projection stop mode according to the time below the specified value, by setting a first specified time and a second specified time. This enables projection control that is independent of individual user differences regarding wiper 6 operation.

it explains the case where the prerequisite is condition C. Note that, condition C is the condition under which wiper 6 operates when the projection apparatus 11 is already illuminated. For example, condition C includes the wiper 6 being in operation. The wiper 6 operation mode here is not limited and may be any of intermittent wiping, low speed wiping, high speed wiping, single wipe, etc. Condition C may also include cases where projection control is performed by comparing the output value of the rain sensor 528 with the operation of the wiper 6. In this case, the comparison result between the output value of the rain sensor 528 and the operation of the wiper 6 may or may not match a preset value.

The processor performs projection control that continues the pre-set illumination mode until illumination ends while wiper 6 is operating (example 7). If illumination has already started, interrupting it midway, it occurs risks misleading to surrounding people or vehicles viewing the projection into thinking the user has canceled the action (e.g., right turn, left turn, lane change) signaled by turning on the directional indicator. To avoid misleading between projection termination based on user intent and termination based on system projection limits, it is desirable to continue projection until the action based on illumination ends.

Furthermore, the running speed of vehicle 2 may affect the wiping speed of wiper 6. For example, when vehicle 2 is traveling at high speed, the behavior of wiper 6 may become faster, potentially affecting it to continuous wiping of wiper 6. Therefore, the values of the specified time, first specified time, and second specified time related to the continuous wiping time of the wiper may be changed according to the running speed of vehicle 2. Note that, it is desirable that the change based on the running speed be such that the time becomes shorter as the running speed increases. This is because the higher the running speed, the more open the area ahead of vehicle 2 becomes, making it more susceptible to glare caused by road surface reflections. Furthermore, a threshold may be set for the vehicle's speed, such that the specified time, first specified time, and second specified time for continuous wiping time are modified only when the speed exceeds this predetermined threshold.

For example, when the vehicle's speed is at or above a predetermined speed, the values of these specified times may be changed to become smaller. Similarly, when the vehicle's speed is below a predetermined speed, the values of these specified times may be changed to become larger.

Furthermore, the ejection of windshield washer fluid may cause false detection by the rain sensor 528. Therefore, when windshield washer fluid is being ejected, the specified time of the rain sensor 528's output value may be increased. Alternatively, the output time of the rain sensor 528 may not be added during the period when windshield washer fluid is being ejected.

Furthermore, in the dimming projection mode, the amount of dimming may be adjusted based on the illuminance around vehicle 2, for example. For instance, when the illuminance around vehicle 2, based on illuminance sensor 505, is darker than a predetermined illuminance level, the amount of dimming may be reduced compared to when it is brighter than that predetermined illuminance level. The size of the human pupil changes depending on the surrounding illuminance. Therefore, the brightness perceived as glare is not constant. Consequently, the target value for dimming should vary with ambient illuminance, and it is desirable to adjust it based on illuminance. When the surroundings are bright, the pupil constricts, making glare from road surface reflections less noticeable. However, when the surroundings are dark, the pupil dilates, making glare from road surface reflections more noticeable. Therefore, when ambient illuminance is dark, either the amount of dimming be increased or projection be stopped.

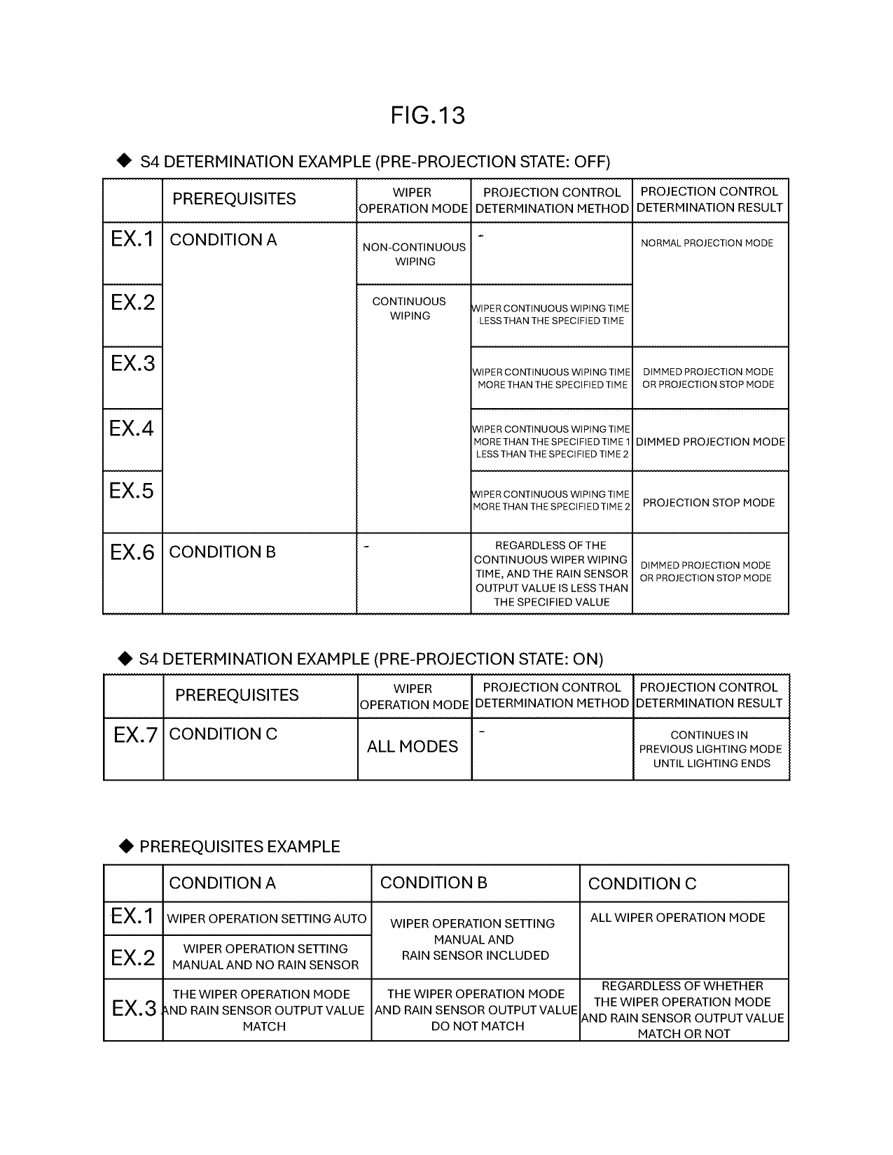

Next, referring to FIG. 14, an example of control in S4 using road surface information is explained. The processor terminates projection when the road surface wetness is at or above the set projection stop level (example 1). When the road surface wetness is at or above the set projection caution level and below the projection stop level, the processor shortens the specified time, first specified time, and second specified time related to the continuous wiping time of wiper, and/or increases the specified value of the output from rain sensor 528, or shortens the specified time (example 2, example 3). As described above, the projection stop level and projection caution level may vary depending on ambient illuminance, considering changes in human pupil size.

Here, the projection caution level and projection stop level for road surface sensor 529 represent the wetness thresholds for the road surface. The projection stop level is a wetness threshold greater than the projection caution level. A road surface condition at or above the projection stop level indicates a wetter condition than a road surface condition at or above the projection caution level but below the projection stop level. Note that the projection caution level and projection stop level may be thresholds based on road surface conditions (e.g., dry, semi-dry, wet, slush, fresh snow, compacted snow, ice). For example, the projection caution level may be a threshold based on the "semi-wet" condition, and the projection stop level may be a threshold based on the "wet" condition, which is wetter than the "semi-wet" condition. Here, the determination may be made by considering the road surface sensor 529 together with the surrounding temperature conditions, etc. This enables detailed control by predicting future changes in road surface conditions, in addition to the current situation.

Furthermore, the processor may acquire road surface information from the vehicle camera (external camera 521) and perform the processing in S4. The processor terminates projection when the road surface illuminance during vehicle 2's light operation is at or above the set projection stop level (example 4). When the road surface illuminance during vehicle 2's light operation is at or above the set projection caution level but below the projection stop level, the processor shortens the specified time, first specified time, and second specified time related to the continuous wiping time of wiper, and/or increases the specified value of the rain sensor 528 output or shortens its specified time (example 5, example 6). As described above, the projection stop level and projection caution level may vary depending on ambient illumination, taking into account changes in human pupil size.

Here, the processor may acquire information on the illuminance of the road surface, which is the subject of the external camera 521, via the external camera 521. The projection caution level and projection stop level for the vehicle camera are thresholds based on road surface illuminance. The projection stop level is a higher road surface illuminance threshold than the projection caution level. A road surface state at or above the projection stop level indicates greater glare than a state at or above the projection caution level but below the projection stop level. Note that, the projection caution level and projection stop level may be thresholds based on the road surface condition (e.g., dry, semi-dry, wet, slush, fresh snow, compacted snow, ice). For example, the projection caution level may be a threshold based on the "semi-wet" condition, and the projection stop level may be a threshold based on the "wet" condition, which has a higher reflectivity than the "semi-wet" condition.

Here, the processor may identify the road surface condition using images from the external camera 521. By detecting the road surface illuminance from the headlights via the external camera 521, changes in the road surface reflectivity can be inferred. Road surface wetting due to rain alters the relationship between the specular reflectivity and diffuse reflectivity of the road surface. Paved roads made of common asphalt or concrete typically have high diffuse reflectivity. This is due to the surface irregularities on the road, which are also designed to aid vehicle braking. However, during rainfall, the surface irregularities are filled by rainwater droplets. Consequently, the diffuse reflectance of the road surface decreases while the specular reflectance increases. This reduces the amount of light reflected back to the user's eyes from the road surface in the vehicle's headlights, and the road appear darker. Conversely, for surrounding people and vehicles, the reflection of headlights from the road surface intensifies, causing glare. Therefore, by capturing the illuminance on the road surface with the external camera 521 it allows the wetness state of the road surface to be determined. Note that, for the above identification, a machine learning model that estimates the road surface state based on input from the external camera 521 image, for example, may also be used.

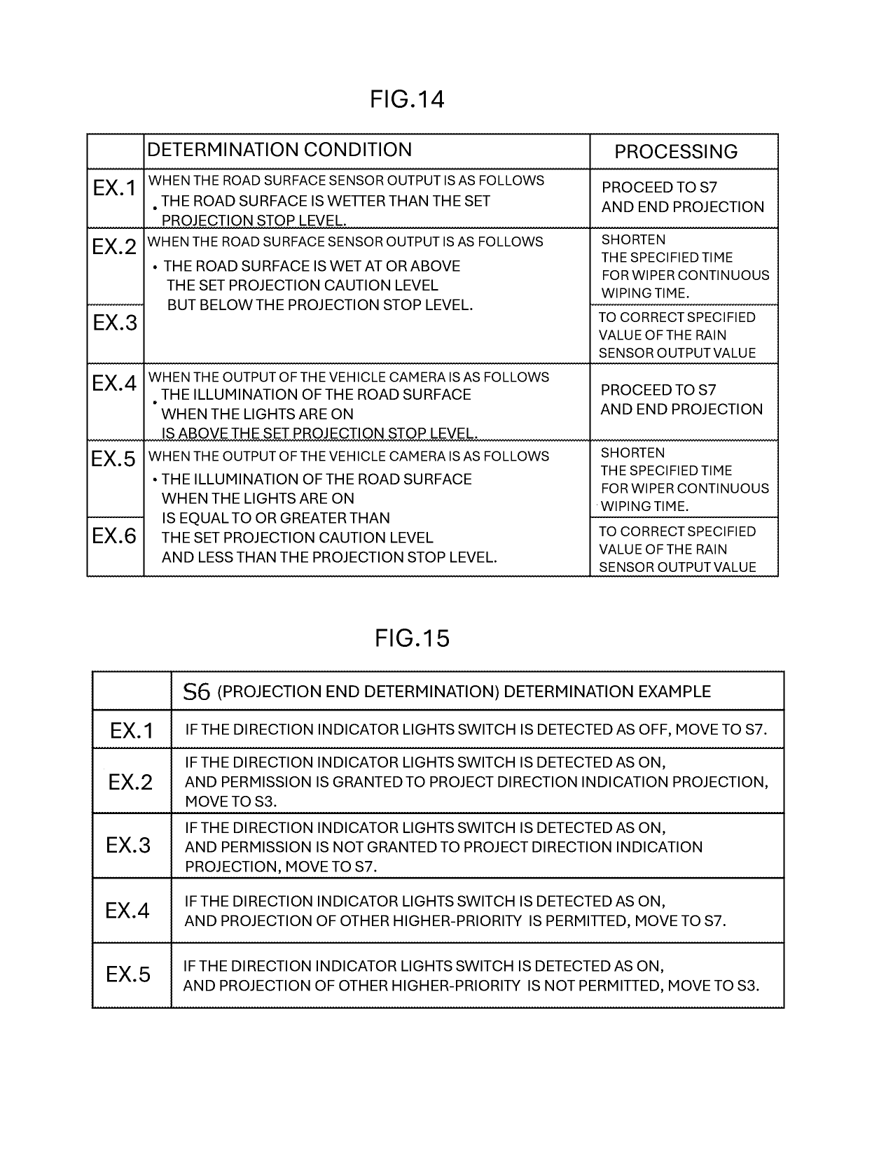

Referring to FIG. 15, an example of the projection termination determination (S6) is explained. When the processor acquires information that the direction indicator lights 14 are not illuminated (i.e., acquires information that the switch to illuminate the direction indicator lights 14 is OFF), it performs the processing in S7 and terminates the projection (example 1). Projection related to direction indication is required to be synchronized with the illumination of the direction indicator lights 14. Therefore, when information is acquired that the direction indicator lights 14 are not illuminated, it is desirable to terminate the projection.

The processor performs the processing of S3 when it acquires information that the direction indicator lights 14 are lit (i.e., information that the switch to turn on the direction indicator lights 14 is ON) and permission is granted to project information corresponding to the direction indicator lights 14 onto the road surface (example 2). On the other hand, if permission to project information corresponding to the information of direction indicator lights 14 onto the road surface is not granted, processing proceeds to S7 (example 3). If the user switches OFF the projection of information corresponding to information of the direction indicator lights 14 onto the road surface via a switch or setting, it is determined that the user does not desire projection. Therefore, even if information indicating the direction indicator lights 14 are lit is acquired, projection is not performed.

The processor acquires information that the direction indicator lights 14 are lit (i.e., acquires information that the switch to light the direction indicator lights 14 is ON) and, if projection of other higher-priority information is not permitted, performs the processing in S3 (example 5). On the other hand, if projection of other higher-priority information is permitted, processing proceeds to S7 (example 4). When the projection apparatus 11 projects multiple information, overlapping information may occur, making it difficult to correctly recognize the information. Furthermore, even if multiple information do not overlap, focusing on another information can make it difficult to simultaneously recognize all displayed information. Therefore, it is desirable to limit the displayed information to that with a higher priority. In this case, the determination may be based on whether the number of simultaneously displayable images is set.

According to the technology described above, a technique is provided that suppresses projections causing glare to surrounding people or vehicles under rainfall conditions. This technology enables projection control based on the operating state of the wiper 6, for example. Note that, projection control can also be performed using sensors (e.g., rain sensor 528, road surface sensor 529, external camera 521).

Although wiper 6 operation is not necessarily linked to road surface conditions (e.g., the road surface may be wet even when it is not raining), combining information from wiper 6 and sensors, for example, enables more appropriate projection control. In S4, projection control may be performed using information from at least one of rain sensor 528, road surface sensor 529, and external camera 521, in addition to wiper 6 operation.

Furthermore, for example, when wiper 6 operates based on driver operation (i.e., when wiper 6 operates under manual control), individual differences exist in how it is operated. Therefore, it enables more appropriate projection control, by judgments from combining other devices, such as rain sensor 528.

In the above, "projection" and "projecting" are used interchangeably. Furthermore, the wiper 6 operation setting is automatic control, it means the setting that the wiper 6 operates automatically based on the output value of the rain sensor 528. The wiper 6 operation setting is manual control, it means the setting that the wiper 6 operates based on the driver's operation.

Furthermore, using the technology described in the above embodiments enables the appropriate display of necessary information, such as images for the driver and images for people around the vehicle. This provides an information projection apparatus that contributes to safe driving, etc. Consequently, it helps suppress traffic accidents. Furthermore, it enables contribution to "3. GOOD HEALTH AND WELL-BEING" of SDGs (Sustainable Development Goals) which is the United Nations advocated.

What is claimed is:

1. An information projection apparatus mounted on a vehicle and projecting images onto a road surface, comprising:
a receiver for acquiring information related to the vehicle; and
a projection or image projector for projecting images,
wherein it determines whether to project an image onto the road surface based on information about the wiper acquired by the receiver.

2. The information projection apparatus according to claim 1,
wherein the information about the wiper acquired by the receiver is the continuous wiping time of the wiper,
the continuous wiping time of the wiper is compared with a preset threshold for continuous wiping time, and based on the comparison result, it is determined whether to project an image onto the road surface,
when the wiper operates continuously and the continuous wiping time exceeds the threshold for continuous wiping time, it projects a dimmed image or do not project an image.

3. The information projection apparatus according to claim 2,
wherein it acquires information regarding the vehicle's traveling speed from the vehicle,
when the traveling speed exceeds a predetermined speed, it changes the threshold for the continuous wiping time of the wiper.

4. The information projection apparatus according to claim 3,
wherein the threshold for the continuous wiping time of the wiper is changed to a smaller value as the traveling speed becomes higher.

5. The information projection apparatus according to claim 1,
wherein the continuous wiping time of the wiper obtained from the vehicle is compared with a preset first threshold for the continuous wiping time of the wiper and a second threshold greater than the first threshold, and based on the comparison result, it determines whether to project an image onto the road surface,
when the wiper operates continuously and the continuous wiping time of the wiper exceeds the first threshold but does not exceed the second threshold, it projects a dimmed image.

6. The information projection apparatus according to claim 5,
wherein when the continuous wiping time of the wiper exceeds the second threshold, projection is not performed.

7. The information projection apparatus according to claim 1,
wherein the information about the wiper acquired by the receiver includes information about the wiper's operating mode,
when the operation mode of the wiper is set to auto control, it determines whether to project an image onto the road surface using the continuous wiping time of the wiper and a threshold related to the continuous wiping time of the wiper.

8. The information projection apparatus according to claim 2,
wherein the information about the wiper acquired by the receiver includes information about the wiper's operating mode,
when the operation mode of the wiper is set to manual control, it determines whether to project an image onto the road surface using the continuous wiping time of wiper, first information based on a threshold value related to the continuous wiping time of wiper, and second information based on the output value of the rain sensor mounted on the vehicle and a threshold value related to the rain sensor's output value.

9. The information projection apparatus according to claim 8,
wherein the first information is information indicating whether the continuous wiping time of the wiper exceeds a threshold for the continuous wiping time of the wiper,
the second information is information indicating whether the output value of the rain sensor exceeds a threshold for the output value of the rain sensor,
in the determination, if both the first information and the second information exceed the thresholds, a dimmed image is projected or projection is not performed.

10. The information projection apparatus according to claim 2,
wherein when the projection or image projector is performing image projection,
even if the continuous wiping time of the wiper exceeds a threshold after the start of the image projection,
the image projection is continued until the trigger condition that initiated the image projection is released.

11. The information projection apparatus according to claim 1,
wherein it determines whether to project an image using information about the road surface acquired by an external camera mounted on the vehicle and a threshold related to the illuminance of the road surface,
it does not project when the road surface illuminance exceeds a preset threshold.

12. An information projection method for an information projection apparatus mounted on a vehicle and projecting images onto a road surface,
wherein the processor acquires information regarding the wiper operation mode,
it determines whether to project an image onto the road surface based on at least one piece of information the continuous wiping time of wiper and the output value of rain sensor, according to the wiper operation mode, and
the processor controls the projection of images by the information projection apparatus based on the result of the determination.
